(19) United States
(12) Patent Application Publication
(10) Pub. No.: US 2024/0052187 A1
(43) Pub. Date: Feb. 15, 2024

(54) AQUEOUS INK, INK CARTRIDGE AND INK JET RECORDING METHOD

(71) Applicant: CANON KABUSHIKI KAISHA, Tokyo (JP)

(72) Inventors: MUTSUKI KUSADA, Chiba (JP); MASAYUKI IKEGAMI, Kanagawa (JP); KENICHI SHIIBA, Saitama (JP); TOMOAKI ISHII, Saitama (JP)

(21) Appl. No.: 18/364,030

(22) Filed: Aug. 2, 2023

(30) Foreign Application Priority Data
Aug. 8, 2022 (JP) 2022-126675
Jul. 11, 2023 (JP) 2023-114071

(51) Int. Cl. C09D 11/322; C09D 11/033; C09D 11/037; C09D 11/102

(52) U.S. Cl. CPC C09D 11/322; C09D 11/033; C09D 11/037; C09D 11/102; B41J 2/17503

(57) ABSTRACT

Provided is an aqueous ink for ink jet including: pigments; a urethane resin; and a silicone-based surfactant. The pigments include a first pigment and a second pigment, the first pigment is a naphthol AS-based azo pigment and the second pigment is a quinacridone-based pigment. The urethane resin is a water-soluble urethane resin having a unit derived from a polyisocyanate, a unit derived from a polyol having no acid group and a unit derived from a polyol having an acid group. The silicone-based surfactant is at least one kind selected from the group consisting of compounds represented by the following respective general formulae (1) to (3), has a weight-average molecular weight of 800 or more to 10,000 or less and has an HLB value measured by Griffin's method of 4 or more.

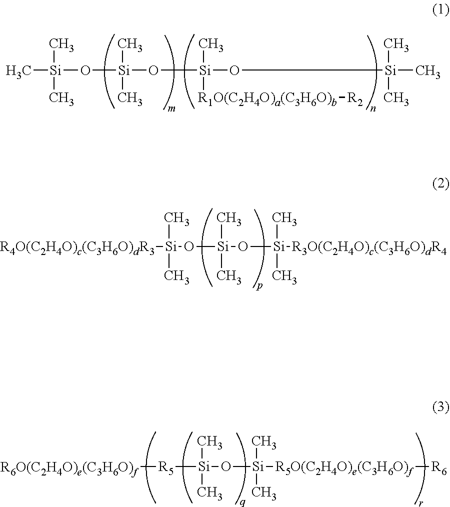

### BACKGROUND OF THE INVENTION

### Field of the Invention

The present invention relates to an aqueous ink, an ink cartridge and an ink jet recording method.

### Description of the Related Art

In recent years, an ink jet recording method has enabled the recording of an image having high definition and an excellent color developability as achieved by silver halide photography or offset recording. A dye or a pigment is available as a coloring material to be used in an ink. Of those, the pigment has been widely used from the viewpoint that an image excellent in fastness property (resistance to, for example, light, an ozone gas or water) can be recorded.

However, an image formed with a pigment ink containing a coloring material dispersed under a particle state in an aqueous medium may be inferior in clarity or a color developability to that formed with a dye ink containing a coloring material present under a dissolved state in an aqueous medium. Accordingly, the following is required: even when the pigment ink is used, a color reproducibility comparable to that of the dye ink is achieved. To cope with such requirement, an improvement in color-developing characteristic of a coloring material for each color of an ink to be used in recording and an increase in content of the coloring material are effective.

A quinacridone-based pigment excellent in fastness property has heretofore been widely used as a pigment to be used in a magenta ink (hereinafter sometimes described as “magenta pigment”). However, the quinacridone-based pigment has a weakness in that its coloring power is weak. Accordingly, even when the content of the pigment is increased, it has been difficult to achieve a high level of the color reproducibility required in recent years.

Meanwhile, an azo pigment has been known as a magenta pigment having a high color developability, high clarity and a wide color reproduction region. Of such pigments, a naphthol AS-based azo pigment is excellent in coloring power. There is a proposal of an ink that can record an image improved in chroma in a magenta to red color gamut and density through combined use of the naphthol AS-based azo pigment and a quinacridone solid solution pigment (Japanese Patent Application Laid-Open No. 2021-014535).

Incidentally, there has been a growing demand for an ink that can record an image excellent in light fastness. There has heretofore been a proposal of an ink containing a UV absorber and a light stabilizer (Japanese Patent Application Laid-Open No. 2016-006150). However, the UV absorber and the light stabilizer may affect the ejectability of the ink. There is a proposal of an ink that can record an image improved in light fastness through the addition of a urethane resin without use of any UV absorber or light stabilizer (Japanese Patent Application Laid-Open No. 2021-008563).

An investigation made by the inventors of the present invention has found that when the ink described in Japanese Patent Application Laid-Open No. 2021-014535, which uses the naphthol AS-based azo pigment and the quinacridone-based pigment in combination, is used, an image excellent in a color developability can be recorded. However, the inventors have found that the image discolors when exposed to light over a long time period because the naphthol AS-based azo pigment has low light fastness. To solve the problem, the inventors of the present invention have investigated an ink containing a urethane resin with reference to Japanese Patent Application Laid-Open No. 2021-008563. As a result, the light fastness of the ink has been improved to some extent, but has not satisfied a level required in recent years. In addition, when an image is recorded under the following condition, there has occurred another problem in that the ejection accuracy of the ink reduces to cause disturbance in the image: a state in which the recovery operation of a recording head is not performed and the ink is not ejected for a certain time period during the image recording or after the recording is established, followed by the restart of the recording. The performance by which the ejection accuracy of the ink can be satisfactorily maintained at the time of the restart of the image recording from such a state as described above is referred to as “intermittent ejection stability.”

### SUMMARY OF THE INVENTION

Accordingly, an object of the present invention is to provide an aqueous ink that can record an image, which is satisfactory in a color developability and light fastness, and has satisfactory intermittent ejection stability. Another object of the present invention is to provide an ink cartridge and an ink jet recording method each using the aqueous ink.

The above-mentioned object is achieved by the present invention described below. That is, according to the present invention, there is provided an aqueous ink for ink jet including: pigments; a urethane resin; and a silicone-based surfactant, wherein the pigments include a first pigment and a second pigment, the first pigment is a naphthol AS-based azo pigment and the second pigment is a quinacridone-based pigment, wherein the urethane resin is a water-soluble urethane resin having a unit derived from a polyisocyanate, a unit derived from a polyol having no acid group and a unit derived from a polyol having an acid group, and wherein the silicone-based surfactant is at least one kind selected from the group consisting of compounds represented by the following respective general formulae (1) to (3), has a weight-average molecular weight of 800 or more to 10,000 or less and has an HLB value measured by Griffin's method of 4 or more:

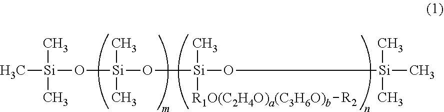

in the general formula (1), R₁ represents an alkylene group, R₂ represents a hydrogen atom or an alkyl group, “m” and “n” each independently represent an integer of 1 or more and “a” and “b” each independently represent an integer of 0 or more but do not simultaneously represent 0;

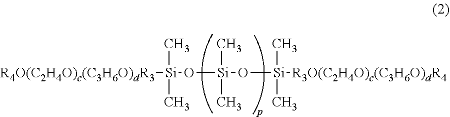

in the general formula (2), R₃ represents an alkylene group, R₄ represents a hydrogen atom or an alkyl group, “p” represents an integer of 1 or more and “c” and “d” each independently represent an integer of 0 or more but do not simultaneously represent 0;

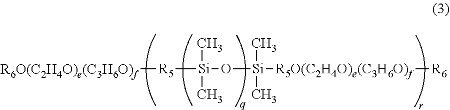

in the general formula (3), R₅ represents an alkylene group, R₆ represents a hydrogen atom or an alkyl group, “q” and “r” each independently represent an integer of 1 or more and “e” and “f” each independently represent an integer of 0 or more but do not simultaneously represent 0.

Further features of the present invention will become apparent from the following description of exemplary embodiments with reference to the attached drawings.

### BRIEF DESCRIPTION OF THE DRAWINGS

FIG. 1 is a sectional view for schematically illustrating an ink cartridge according to one embodiment of the present invention.

FIG. 2A and FIG. 2B are views for schematically illustrating an example of an ink jet recording apparatus to be used in an ink jet recording method of the present invention, in which FIG. 2A is a perspective view of the main portion of the ink jet recording apparatus and FIG. 2B is a perspective view of a head cartridge.

### DESCRIPTION OF THE EMBODIMENTS

The present invention is described in more detail below by way of exemplary embodiments. In the present invention, when the ink contains a salt, the salt is present in a state of dissociating into ions in an ink, but the expression “contains the salt” is used for convenience. In addition, an aqueous ink for ink jet is sometimes simply described as “ink”. Physical property values are values at normal temperature (25° C.) unless otherwise stated.

To record an image excellent in a color developability and light fastness, the inventors of the present invention have investigated an ink including a naphthol AS-based azo pigment, a quinacridone-based pigment and a urethane resin. As a result of the investigation, the inventors have revealed that when an image is recorded under a specific condition, the ejection accuracy of the ink reduces to cause disturbance in the image.

When the surface of a recording head having formed therein an ejection orifice is brought into contact with air, the evaporation of a liquid component (mainly water) from the ink occurs from the tip (ejection orifice) of a nozzle from which the ink is ejected. When a state in which the recovery of the recording head is not performed and the ink is not ejected for a certain time period at the time of the image recording continues, the evaporation of the liquid component from the ejection orifice advances to concentrate the ink. Accordingly, normal ejection of the ink may not be performed owing to the thickening of the ink or the clogging of the ejection orifice. The performance by which even in such a state as described above, the ejection accuracy of the ink can be satisfactorily maintained at the time of the restart of the image recording is referred to as “intermittent ejection stability.” The inventors have revealed that in the ink including the naphthol AS-based azo pigment, the quinacridone-based pigment and the urethane resin, the intermittent ejection stability is liable to reduce.

The inventors of the present invention have investigated a cause for the reduction in intermittent ejection stability of the ink including the naphthol AS-based azo pigment, the quinacridone-based pigment and the urethane resin. First, the observation of the recording head reduced in intermittent ejection stability has found that an aggregate deposits in an ink flow path. Such deposited aggregate is assumed to inhibit the normal ejection of the ink to be responsible for a reduction in ejection accuracy thereof. As a result of a further investigation, the inventors have found that the above-mentioned aggregate does not occur in an ink, which is free of even one of the three components, that is, the naphthol AS-based azo pigment, the quinacridone-based pigment and the urethane resin, but occurs peculiarly when the three components coexist in the ink. The inventors of the present invention have assumed a cause for the occurrence of the aggregate to be as described below.

The quinacridone-based pigment shows a specifically high affinity for the urethane resin because of the following two interactions: a hydrophobic interaction and a hydrogen bond. Accordingly, the urethane resin may be liable to adsorb to the quinacridone-based pigment.

First, the quinacridone-based pigment is liable to cause the adsorption of the urethane resin because of the hydrophobic interaction. The urethane resin typically includes a hard segment that expresses strength and a soft segment that expresses flexibility. The hard segment includes, for example, a unit derived from a polyisocyanate, a unit derived from an acid group-containing component and a unit derived from a chain extender. The soft segment includes a unit derived from a polyol or the like. In general, the hard segment is a hydrophobic moiety and the soft segment is a hydrophilic moiety. The quinacridone-based pigment strongly interacts with the hard segment of the urethane resin because the pigment is a pigment that has a plurality of aromatic rings and hence has high hydrophobicity.

Further, the quinacridone-based pigment is also liable to cause the adsorption of the urethane resin because of the hydrogen bond. The quinacridone-based pigment including a molecule having a high-planarity structure has a crystal structure laminated in a direction perpendicular to its molecular plane by the π-π stacking of the aromatic rings. At this time, a crystal plane in which the structures of a quinacridone skeleton, such as an amino group and a carbonyl group, are densely distributed is assumed to be present in a direction perpendicular to the lamination direction. In the crystal plane, an amino group serving as a proton donor and a carbonyl group serving as a proton acceptor are abundantly present. Meanwhile, a urethane bond and a urea bond are present in a bonding moiety between the hard segment and the soft segment of the urethane resin. The quinacridone-based pigment is assumed to be able to form an extremely strong hydrogen bond because those bonds also have both structures that may serve as a proton donor and a proton acceptor.

Magenta pigments each having a skeleton except quinacridone, for example, pigments, such as anthrapyridone and dioxazine, each have a molecular skeleton in which aromatic rings lie in a row and hence the pigments each have high hydrophobicity. However, the interaction of each of those pigments with the urethane resin is weaker than that of the quinacridone-based pigment because each of the pigments has a carbonyl group serving as a proton acceptor but is free of a structure serving as a proton donor. Although diketopyrrolopyrrole has both of a carbonyl group serving as a proton acceptor and an amino group serving as a proton donor, it does not have an affinity for the urethane resin as high as that of the quinacridone-based pigment because diketopyrrolopyrrole has low hydrophobicity. The quinacridone-based pigment, which has high hydrophobicity and has the following substituents, is assumed to be liable to specifically interact with the urethane resin: the substituents easily form hydrogen bonds and are present in a densely distributed manner in a certain direction of the crystal of the pigment.

Meanwhile, the interaction of the naphthol AS-based azo pigment out of the magenta pigments with the urethane resin may be particularly weak. The naphthol AS-based azo pigment has a hydrophilic group, such as a carbamoyl group or a hydroxy group. Accordingly, the particle surface of the pigment has a high hydrophilicity and hence hardly causes the adsorption of the urethane resin. In addition, unlike the quinacridone-based pigment, the naphthol AS-based azo pigment hardly forms a crystal plane in which substituents that can form hydrogen bonds are densely distributed. Thus, the affinity of the pigment for the urethane resin may be specifically low.

Under such an environment that, as described above, the pigment having a specifically high affinity for the urethane resin and the pigment having a specifically low affinity for the urethane resin coexist with the urethane resin in the ink and the ink is concentrated to shorten a distance between both the pigments, to thereby facilitate an interaction therebetween, such a phenomenon as described below is assumed to occur.

When the ink is concentrated, most of the urethane resin that has adsorbed to the naphthol AS-based azo pigment desorbs from the particle surface of the naphthol AS-based azo pigment and adsorbs to the particle surface of the quinacridone-based pigment on which a stronger interaction acts. At this time, the desorption of the urethane resin destabilizes the dispersed state of the naphthol AS-based azo pigment. The destabilized naphthol AS-based azo pigment forms an associate with another particle of the naphthol AS-based azo pigment or the quinacridone-based pigment. Further, the urethane resin strongly interacts with the quinacridone-based pigment in the associate to crosslink the molecules of the associate. Thus, an aggregate having a strong binding force occurs. It is difficult to redisperse the aggregate through the flow of the ink occurring in the ink flow path because the three components, that is, the naphthol AS-based azo pigment, the quinacridone-based pigment and the urethane resin strongly interact with each other through a hydrophobic interaction and a hydrogen bond to be intricately intertwined with each other. Accordingly, the recording head is not recovered by a recovery operation such as preliminary ejection and hence the aggregate may gradually deposit in the ink flow path to reduce the intermittent ejection stability of the ink.

When the ink includes the quinacridone-based pigment and the urethane resin and is free of the naphthol AS-based azo pigment or when the ink includes the naphthol AS-based azo pigment and the urethane resin and is free of the quinacridone-based pigment, the problem in that the intermittent ejection stability reduces does not occur. This is because of the following reason: because the ink is free of one of the quinacridone-based pigment and the naphthol AS-based azo pigment, the adsorption and desorption of the urethane resin between both the pigments described above do not occur and hence the dispersed state of the pigment is hardly destabilized. In addition, in the case where the ink includes the naphthol AS-based azo pigment and the quinacridone-based pigment and is free of the urethane resin, the pigments may be brought close to each other to destabilize their dispersed states, to thereby form an associate. In this case, however, a binding force between the pigments is weak because crosslinking by the urethane resin does not occur. The intermittent ejection stability does not reduce because the associate is redispersed by the flow of the ink in the ink flow path and hence does not deposit in the ink flow path. In this case, however, the ink is free of the urethane resin and hence the light fastness of an image formed with the ink reduces. Thus, it is impossible to simultaneously satisfy all of the color developability and light fastness of the image, and the intermittent ejection stability of the ink. Even when, for example, an acrylic resin is incorporated as a resin except the urethane resin, no aggregate occurs but it is difficult to simultaneously satisfy the light fastness.

The inventors of the present invention have investigated the configuration of an aqueous ink that achieves both of the color developability and light fastness of an image and intermittent ejection stability. As a result, the inventors have found that the addition of a specific silicone-based surfactant to an ink including a naphthol AS-based azo pigment, a quinacridone-based pigment and a urethane resin provides an ink that can record an image, which is satisfactory in a color developability and light fastness, and has satisfactory intermittent ejection stability. Since the ink has satisfactory intermittent ejection stability, the ink has satisfactory ejection accuracy, and disturbance hardly occurs in an image to be recorded with the ink.

The inventors of the present invention have assumed the reason why such an effect as described above is obtained to be as described below. Compounds represented by the respective general formulae (1) to (3) to be described later, which may each be used as the above-mentioned specific silicone-based surfactant, each have an ethylene oxide group and/or a propylene oxide group. A lone pair is present in the oxygen atom of the ethylene oxide group and/or the propylene oxide group in the silicone-based surfactant and hence such group can serve as an electron donor to form a hydrogen bond with a polarized hydrogen atom. At this time, the degree of the polarization of the ethylene oxide group and/or the propylene oxide group is small. Accordingly, it is conceivable that the electron-donating property of such a group is small and hence the hydrogen bond formed by the silicone-based surfactant is relatively weak.

When the silicone-based surfactant represented by the general formula (1), (2) or (3) is added to the ink including the naphthol AS-based azo pigment, the quinacridone-based pigment and the urethane resin, the silicone-based surfactant adsorbs to the quinacridone-based pigment or the urethane resin. Thus, a part of strong hydrogen bonds formed between the quinacridone-based pigment and the urethane resin are replaced with the weak hydrogen bond formed by the silicone-based surfactant described above. Thus, an interaction acting between the quinacridone-based pigment and the urethane resin is loosened and hence the urethane resin that has adsorbed to the naphthol AS-based azo pigment is hardly deprived of by the quinacridone-based pigment. Accordingly, the dispersed state of the naphthol AS-based azo pigment is stably kept.

Further, the silicone-based surfactant adsorbs to the particle surface of the naphthol AS-based azo pigment, though its adsorption amount is small. Thus, the ethylene oxide group and/or propylene oxide group of the silicone-based surfactant is present near the naphthol AS-based azo pigment. The dispersed state of the naphthol AS-based azo pigment is more stably kept because the pigment easily interacts with the urethane resin through the hydrogen bonding moiety.

The intermittent ejection stability is improved probably because the silicone-based surfactant weakens the hydrogen bonds between the quinacridone-based pigment and the urethane resin to suppress the occurrence of an aggregate in which the three components are aggregated by a strong force.

The intermittent ejection stability is not improved by use of any other surfactant having an ethylene oxide group and/or a propylene oxide group, such as an acetylene glycol-based surfactant, a fluorine-based surfactant or a polyoxyalkylene alkyl ether-based surfactant. The inventors of the present invention have assumed the reason why the effect is obtained only when the silicone-based surfactant is used to be as described below.

The silicone-based surfactant is a compound having, as a main skeleton, a siloxane bond in which a silicon atom and an oxygen atom alternately lie in a row. The siloxane bond is characterized in that a bond distance between the atoms is long and a bond angle therebetween is large. The siloxane bond has high flexibility and a high degree of freedom in bonding by virtue of the characteristic.

A hydrogen bond has direction dependence and hence the bond can be formed only in a specific direction. It is conceivable that the silicone-based surfactant in which the degree of freedom in arrangement of the main skeleton is high may have such a molecular arrangement that an ethylene oxide group and/or a propylene oxide group serving as a hydrogen bonding moiety can efficiently interact with a hydrogen bonding moiety of the quinacridone-based pigment or the urethane resin. Probably because of the foregoing, the silicone-based surfactant can weaken the hydrogen bond between the quinacridone-based pigment and the urethane resin. Meanwhile, each of a carbon-fluorine bond and a carbon-carbon bond has an interatomic distance shorter than that of the siloxane bond and hence has a low degree of freedom. Accordingly, in each of the fluorine-based surfactant and the polyoxyalkylene alkyl ether-based surfactant having those bonds as their main skeletons, it may be difficult to arrange a hydrogen bonding moiety at an appropriate position at which the moiety can be hydrogen-bonded to the quinacridone-based pigment or the urethane resin. Probably because of the foregoing, neither the fluorine-based surfactant nor the polyoxyalkylene alkyl ether-based surfactant can loosen the hydrogen bond between the quinacridone-based pigment and the urethane resin and hence the intermittent ejection stability is not improved.

In addition, the acetylene glycol-based surfactant does not improve the intermittent ejection stability probably because its orientation to a gas-liquid interface is too fast. When the orientation to the gas-liquid interface is too fast, the surfactant quickly adsorbs to the ink flow path and is hence lost from the vicinities of the pigments and the urethane resin. When recording is paused for a long time period, a large part of the surfactant desorbs from the pigments and the urethane resin. Accordingly, the hydrogen bond between the quinacridone-based pigment and the urethane resin cannot be loosened and hence the intermittent ejection stability reduces. The orientation of the silicone-based surfactant to the gas-liquid interface is slower than that of any other surfactant. Accordingly, even when the pause time of the recording is long, the silicone-based surfactant hardly adsorbs to the ink flow path and hence the silicone-based surfactant remaining near the pigments and the urethane resin is present in a large amount. Accordingly, the silicone-based surfactant can loosen the hydrogen bond between the quinacridone-based pigment and the urethane resin and hence the intermittent ejection stability is improved.

To obtain the above-mentioned effect, the silicone-based surfactant to be incorporated into the ink needs to have a weight-average molecular weight of 800 or more to 10,000 or less. When the weight-average molecular weight of the silicone-based surfactant is more than 10,000, the molecular size thereof becomes larger and hence the surfactant is hardly present near the urethane resin and the quinacridone-based pigment owing to steric hindrance. In that case, the hydrogen bonds between the urethane resin and the quinacridone-based pigment cannot be loosened and hence an improving effect on the intermittent ejection stability is not obtained. Meanwhile, when the weight-average molecular weight of the silicone-based surfactant is less than 800, the number of units of ethylene oxide groups and/or propylene oxide groups necessarily reduces. When the number of those units that can form hydrogen bonds is small, an improving effect on the intermittent ejection stability is not obtained because the following action becomes excessively weak: the units form hydrogen bonds instead of the urethane resin and the quinacridone-based pigment to loosen the interaction between the urethane resin and the quinacridone-based pigment.

In addition, the HLB value of the silicone-based surfactant measured by Griffin's method needs to be 4 or more. When the HLB value is less than 4, the silicone-based surfactant cannot be dissolved in the ink and hence an improving effect on the intermittent ejection stability cannot be obtained.

Further, the use of the ink including the silicone-based surfactant not only improves the intermittent ejection stability but also is able to further improve the light fastness of an image. The inventors of the present invention have assumed the reason for the foregoing to be as described below. An image recorded with an ink, which included the naphthol AS-based azo pigment, the quinacridone-based pigment and the urethane resin and was free of the silicone-based surfactant, was observed with an electron microscope. As a result, it was recognized that a substance having an indeterminate form, which was assumed to be the urethane resin, did not uniformly cover the entirety of the particle surface of each of the pigments but was unevenly distributed. As described above, a strong hydrogen bond acts between the quinacridone-based pigment and the urethane resin. It is assumed that the particle surface of the naphthol AS-based azo pigment is present under an exposed state because, as a result of the foregoing, much of the urethane resin adsorbs to the quinacridone-based pigment in the ink and hence the adsorption amount thereof to the naphthol AS-based azo pigment reduces. The light fastness reduces probably because the naphthol AS-based azo pigment that is not sufficiently covered with the urethane resin is not protected from light and is hence directly exposed to direct sunlight, light from a fluorescent lamp or the like.

Herein, when the silicone-based surfactant is incorporated into the ink, as described above, the silicone-based surfactant acts on the quinacridone-based pigment and the urethane resin to weaken the specifically strong hydrogen bond acting therebetween. In other words, bias between the adsorption amounts of the urethane resin to the naphthol AS-based azo pigment and the quinacridone-based pigment can be eliminated. When an image is recorded with such an ink, the uneven distribution of the urethane resin on a pigment layer is eliminated and hence a state in which the naphthol AS-based azo pigment and the quinacridone-based pigment are evenly covered with the resin is easily established. The light fastness of the image is improved probably because a state in which the naphthol AS-based azo pigment having low light fastness is protected from light is easily established.

Further, the silicone-based surfactant in the ink improves the uniformity of a film of the urethane resin to be formed. The aggregation of the molecules of the urethane resin at the time of the formation of the film by the urethane resin in the pigment layer is suppressed because the ethylene oxide group and/or propylene oxide group of the silicone-based surfactant loosens a hydrogen bond between the molecules of the urethane resin. Probably as a result of the foregoing, the pigments are more easily covered with the urethane resin and hence an improving effect on the light fastness is obtained.

In addition, to obtain the above-mentioned effect, the urethane resin needs to be water-soluble. When the urethane resin is water-dispersible, the thickening of the ink hardly occurs at the time of the evaporation of its liquid component. Accordingly, when a recording medium into which the ink easily permeates is used, the urethane resin does not remain in the pigment layer and hence it is impossible to record an image excellent in light fastness. In addition, even when the quinacridone-based pigment is not incorporated into the ink, the urethane resin permeates into the recording medium and hence cannot be efficiently left in the pigment layer of the image. Accordingly, the light fastness of the image is not improved. It is conceivable from the foregoing that the quinacridone-based pigment has the following action, though its specific interaction with the urethane resin is weakened: the pigment interacts with the urethane resin to keep the urethane resin in the pigment layer.

<Ink>

As described above, the ink of the present invention is an aqueous ink for ink jet including specific pigments, a specific urethane resin and a specific silicone-based surfactant. The ink of the present invention does not need to be a so-called “curable ink.” Accordingly, the ink of the present invention may be free of a compound such as a polymerizable monomer that can be polymerized by the application of external energy. The respective components for forming the ink and the like are described in detail below.

(Pigments)

The ink includes, as its pigments, at least the naphthol AS-based azo pigment serving as a first pigment and the quinacridone-based pigment serving as a second pigment. One or two or more kinds of the first pigments and one or two or more kinds of the second pigments may be incorporated into the ink.

[First Pigment]

The first pigment is the naphthol AS-based azo pigment. The azo pigment is a pigment formed of a compound having a structure obtained by coupling a diazo component, which is obtained by diazotizing an aromatic amine, and a coupler component. The naphthol AS-based azo pigment is obtained by using any one of naphthol ASs as the coupler component. The term “naphthol AS” refers to 3-hydroxy-2-carboxynaphthalene anilide and the term “naphthol ASs” is a generic name for compounds different from each other in substitution position of a hydroxy group or carboxynaphthalene anilide.

Specific examples of the naphthol AS-based azo pigment may include: C.I. Pigment Reds 2, 5, 17, 22, 31, 112, 146, 147, 150, 170, 176, 185, 266 and 269; C.I. Pigment Orange 22; and C.I. Pigment Violet 50. Of those naphthol AS-based azo pigments, C.I. Pigment Reds 31, 146, 147, 150 and 269 are preferred, and C.I. Pigment Red 150 is more preferred. In each of C.I. Pigment Reds 31, 146, 147, 150 and 269, a compound represented by the following general formula (4) is used as a coupler component. A naphthol AS-based azo pigment obtained by using a coupler component having such a structure easily improves the light fastness of an image because the pigment easily forms a hydrogen bond with the urethane resin. In addition, the intermittent ejection stability of the ink is easily improved because the dispersed state of the first pigment in the ink in a concentrated state is easily kept stable.

C.I. Pigment Red 150 is preferably used because the light fastness can be further improved. In C.I. Pigment Red 150, out of the compounds each represented by the following general formula (4), such a compound that R₇ in the formula represents a hydrogen atom is used as a coupler component. In C.I. Pigment Red 150 having such structure through the use of the coupler component, two hydrogen atoms bonded to the nitrogen atom of a CONH₂ group can each form a hydrogen bond. Accordingly, C.I. Pigment Red 150 more easily interacts with the urethane resin and hence the light fastness of the image and the intermittent ejection stability of the ink are easily improved.

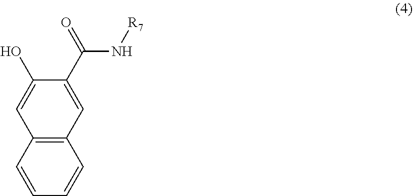

In the general formula (4), R₇ represents a hydrogen atom or a group represented by the following general formula (5).

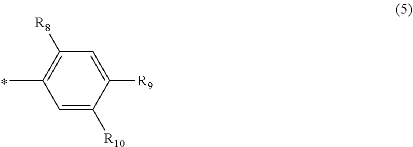

In the general formula (5), R₈, R₉ and R₁₀ each represent any one of the following (5-1) to (5-4) and * represents a bonding site with a nitrogen atom to which R₇ in the general formula (4) is bonded.
(5-1) R₈ and R₉ each represent a hydrogen atom and R₁₀ represents a nitro group.
(5-2) R₈ and R₁₀ each represent a methoxy group and R₉ represents a chlorine atom.
(5-3) R₈ represents a methyl group, R₉ represents a hydrogen atom and R₁₀ represents a chlorine atom.
(5-4) R₈ represents a methoxy group, R₉ represents a hydrogen atom and R₁₀ represents a chlorine atom.

[Second Pigment]

The second pigment is a quinacridone-based pigment. The quinacridone-based pigment is a pigment formed of quinacridone (5,12-dihydro-quino[2,3-b]acridine-7,14-dione) or a quinacridone derivative.

Specific examples of the quinacridone-based pigment may include: C.I. Pigment Reds 122, 192, 202, 206, 207 and 209; and C.I. Pigment Violet 19. A solid solution of two or more kinds of quinacridone-based pigments may be used. The solid solution is also referred to as “mixed crystal” and two or more kinds of pigments dissolve together to form a uniform solid phase as a whole. The solid solution is different from a product obtained by simply mixing the two or more kinds of pigments. As commercial products of the solid solution of two or more kinds of quinacridone-based pigments, there may be given, for example, products available under the product names “CROMOPHTAL Jet 2BC” (manufactured by Ciba Specialty Chemicals Corporation), “Cinquasia Magenta D 4500 J” and “Cinquasia Magenta D 4400” (each of which is manufactured by BASF Corporation), “Inkjet Magenta E 02”, “Inkjet Magenta E7B LV 3958” and “Inkjet Magenta E7B 02 VP 3958” (each of which is manufactured by Clariant AG Corporation) and “FASTOGEN Super Magenta JM2120” (manufactured by DIC Corporation).

A solid solution pigment containing C.I. Pigment Red 122 and C.I. Pigment Violet 19 out of the above-mentioned quinacridone-based pigments is preferred. In a quinacridone solid solution, strain occurs in its array during a process for the formation of its crystal. Accordingly, the frequency at which an amino group of a quinacridone skeleton appears on the surface of the crystal is higher than that of a pigment formed of one kind of quinacridone. Accordingly, the solid solution easily forms a hydrogen bond with the urethane resin. Meanwhile, when a quinacridone-based pigment for forming a solid solution has a bulky substituent, disturbance occurs in the hydrogen bonding surface of the solid solution owing to the steric hindrance of the substituent to suppress the adsorption of the urethane resin. In the solid solution pigment containing C.I. Pigment Red 122 substituted with a methyl group and C.I. Pigment Violet 19 that is unmodified quinacridone, the size of the substituent is small. Accordingly, the hydrogen bonding surface of the solid solution is hardly disturbed and hence the adsorption amount of the urethane resin thereto increases. Accordingly, the light fastness is easily improved.

Any other pigment may be incorporated into the ink as required in addition to the above-mentioned pigments. Examples of the other pigment may include inorganic pigments such as carbon black and organic pigments known in the art. The proportion of the total content (% by mass) of the first pigment and the second pigment relative to the content (% by mass) of the pigments in the aqueous ink is preferably 95.0% by mass or more and may be 100.0% by mass.

[System for Dispersion of Pigments]

A system for the dispersion of the pigments may be, for example, a resin-dispersed pigment using a resin dispersant, a pigment dispersed with a surfactant or such a microcapsule pigment that at least a part of its particle surface is covered with a resin or the like. In addition, for example, a self-dispersible pigment having a functional group, which includes a hydrophilic group such as an anionic group, bonded to its particle surface or a pigment (resin-bonded type self-dispersible pigment) having an organic group containing a high polymer chemically bonded to its particle surface may be used. A pigment of any dispersion system may be used in the ink. Further, pigments different from each other in dispersion system may be used in combination. Of those, a system including dispersing a pigment through the action of a resin dispersant that is caused to physically adsorb to its particle surface (resin-dispersed pigment) is preferred.

[Content of Pigments]

The content (% by mass) of the pigments (total of the first pigment and the second pigment) in the ink is preferably 0.10% by mass or more to 15.00% by mass or less, more preferably 1.00% by mass or more to 10.00% by mass or less with respect to the total mass of the ink. The content (% by mass) of the first pigment (naphthol AS-based azo pigment) in the ink is preferably 0.02% by mass or more to 3.00% by mass or less, more preferably 0.20% by mass or more to 2.00% by mass or less with respect to the total mass of the ink. The content (% by mass) of the second pigment (quinacridone-based pigment) in the ink is preferably 0.08% by mass or more to 12.00% by mass or less, more preferably 0.80% by mass or more to 8.00% by mass or less with respect to the total mass of the ink. In the ink, the content (% by mass) of the first pigment (naphthol AS-based azo pigment) is preferably smaller than the content (% by mass) of the second pigment (quinacridone-based pigment).

In the ink, the mass ratio of the content (% by mass) of the pigments to the content (% by mass) of the urethane resin is preferably 1.00 times or more and is preferably 25.00 times or less, more preferably 6.00 times or less. When the above-mentioned mass ratio is 1.00 times or more, the ratio of the urethane resin in the pigment layer of an image is suppressed and hence the surface smoothness of the pigment layer is improved. Accordingly, scattering hardly occurs and hence the color developability of the image is easily improved. Meanwhile, when the above-mentioned mass ratio is 25.00 times or less, the pigments are sufficiently covered with the urethane resin and hence an improving effect on the light fastness of the image is easily obtained.

In the ink, the mass ratio of the content (% by mass) of the second pigment (quinacridone-based pigment) to the content (% by mass) of the pigments is preferably 0.80 times or more and is preferably 0.95 times or less, more preferably 0.94 times or less. When the above-mentioned mass ratio is 0.80 times or more, the mass ratio of the quinacridone-based pigment having such a property as to easily adsorb the urethane resin is high and hence the amount of the urethane resin present in the pigment layer becomes sufficient. Accordingly, an improving effect on the light fastness of the image is easily obtained. Meanwhile, when the above-mentioned mass ratio is 0.95 times or less, the content of the naphthol AS-based azo pigment excellent in color development efficiency can be secured and hence the color developability of the image is easily improved. In addition, in the aqueous ink, the mass ratio of the content (% by mass) of the first pigment (naphthol AS-based azo pigment) to the content (% by mass) of the pigments is preferably 0.01 times or more to 0.20 times or less. In the ink, the mass ratio of the content (% by mass) of the first pigment (naphthol AS-based azo pigment) to the content (% by mass) of the second pigment (quinacridone-based pigment) is preferably 0.01 times or more to 0.50 times or less, more preferably 0.01 times or more to 0.40 times or less.

(Urethane Resin)

The urethane resin has a unit derived from a polyisocyanate, a unit derived from a polyol having no acid group and a unit derived from a polyol having an acid group. One or two or more kinds of the urethane resins having these units may be incorporated into the ink. The “unit” of the resin as used herein means a repeating unit derived from one monomer.

The content (% by mass) of the urethane resin in the ink is preferably 0.10% by mass or more to 10.00% by mass or less, more preferably 0.10% by mass or more to 6.00% by mass or less with respect to the total mass of the ink. When the content (% by mass) of the urethane resin is 0.10% by mass or more, an improving effect on the light fastness of an image is easily obtained. When the content (% by mass) of the urethane resin is 10.00% by mass or less, an increase in viscosity of the ink is suppressed and hence the ejection stability of the ink is easily maintained.

[Polyisocyanate]

The polyisocyanate is a compound having 2 or more isocyanate groups in a molecular structure thereof. Examples of the polyisocyanate may include an aliphatic polyisocyanate, an alicyclic polyisocyanate, an aromatic polyisocyanate and an aromatic-aliphatic polyisocyanate. Those polyisocyanates may be used alone or in combination thereof. The proportion (% by mass) of a unit derived from the polyisocyanate in the urethane resin is preferably 10.0% by mass or more to 80.0% by mass or less.

Examples of the aliphatic polyisocyanate may include tetramethylene diisocyanate, dodecamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate and 3-methylpentane-1,5-diisocyanate. Examples of the alicyclic polyisocyanate may include isophorone diisocyanate, hydrogenated xylylene diisocyanate, 4,4′-dicyclohexylmethane diisocyanate, 1,4-cyclohexane diisocyanate, methylcyclohexylene diisocyanate and 1,3-bis(isocyanatomethyl)cyclohexane.

Examples of the aromatic polyisocyanate may include tolylene diisocyanate, 2,2′-diphenylmethane diisocyanate, 2,4′-diphenylmethane diisocyanate, 4,4′-diphenylmethane diisocyanate, 4,4′-dibenzyl diisocyanate, 1,5-naphthylene diisocyanate, xylylene diisocyanate, 1,3-phenylene diisocyanate and 1,4-phenylene diisocyanate. Examples of the aromatic-aliphatic polyisocyanate may include a dialkyldiphenylmethane diisocyanate, a tetraalkyldiphenylmethane diisocyanate and α,α,α′,α′-tetramethylxylylene diisocyanate.

Of the above-mentioned polyisocyanates, isophorone diisocyanate is preferred. In the structure of a polyurethane resin, a unit derived from the polyisocyanate is present as a hydrophobic moiety. Of the polyisocyanates, isophorone diisocyanate has particularly strong hydrophobicity because carbon at the 3-position of its cyclohexane ring has two methyl groups. Accordingly, when a polyurethane resin having a unit derived from isophorone diisocyanate is used, the silicone-based surfactant easily adsorbs thereto because of a hydrophobic interaction therebetween. When a large amount of the silicone-based surfactant adsorbs, a weakening action on a hydrogen bond between the urethane resin and the quinacridone-based pigment strengthens and hence the intermittent ejection stability of the ink and the light fastness of an image formed with the ink are easily improved.

[Polyol Having No Acid Group]

Examples of the polyol having no acid group may include a polyester polyol, a polyether polyol, a polycarbonate polyol, a polyhydroxy polyacetal, a polyhydroxy polyacrylate, a polyhydroxy polyester amide and a polyhydroxy polythioether. Those polyols having no acid groups may be used alone or in combination thereof.

The polyol having no acid group preferably has a number-average molecular weight of 1,500 or more to 4,000 or less. When the number-average molecular weight of the polyol having no acid group is 1,500 or more, the polyol serving as a soft segment in the urethane resin has a long chain length and hence the mobility of a urethane molecular chain is improved. Accordingly, a hydrogen bond is hardly formed between the hard segments of the molecules of the urethane resin. As a result, the number of the moieties of the urethane resin that can form hydrogen bonds with the pigments increases and hence the amount of the urethane resin remaining on the pigment layer of an image increases. Accordingly, an improving effect on the light fastness of the image is easily obtained. Meanwhile, when the number-average molecular weight of the polyol having no acid group is 4,000 or less, the hydrophilicity of the urethane resin is easily made moderate and hence the adsorption amount of the silicone-based surfactant thereto increases. Accordingly, a hydrogen bond between the resin and the quinacridone-based pigment is easily weakened and hence improving effects on the intermittent ejection stability of the ink and the light fastness of the image are easily obtained.

An example of the polyester polyol may be an ester of an acid component and a polyalkylene glycol, a dihydric alcohol or a polyhydric alcohol that is trihydric or more. Examples of the acid component may include an aromatic dicarboxylic acid, an alicyclic dicarboxylic acid and an aliphatic dicarboxylic acid. Examples of the aromatic dicarboxylic acid may include isophthalic acid, terephthalic acid, orthophthalic acid, napthalenedicarboxylic acid, biphenyldicarboxylic acid and tetrahydrophthalic acid. Examples of the alicyclic dicarboxylic acid may include hydrogenated products of the aromatic dicarboxylic acids described above. Examples of the aliphatic dicarboxylic acid may include malonic acid, succinic acid, tartaric acid, oxalic acid, glutaric acid, adipic acid, pimelic acid, suberic acid, azelaic acid, sebacic acid, an alkylsuccinic acid, linoleic acid, maleic acid, fumaric acid, mesaconic acid, citraconic acid and itaconic acid. A reactive derivative, such as an acid anhydride, an alkyl ester or an acid halide, of each of those acid components may also be used as the acid component for forming the polyester polyol. Those acid components may be used alone or in combination thereof.

Examples of the polyalkylene glycol may include polyethylene glycol, polypropylene glycol, polytetramethylene glycol and an ethylene glycol-propylene glycol copolymer. Examples of the dihydric alcohol may include hexamethylene glycol, tetramethylene glycol, ethylene glycol, diethylene glycol, propylene glycol, dipropylene glycol, 1,3-butanediol, 1,4-butanediol, 4,4-dihydroxyphenylpropane and 4,4-dihydroxyphenylmethane. Examples of the polyhydric alcohol that is trihydric or more may include glycerin, trimethylolpropane, 1,2,5-hexanetriol, 1,2,6-hexanetriol and pentaerythritol. Those polyester polyols may be used alone or in combination thereof.

Examples of the polyether polyol may include addition polymers of a polyalkylene glycol and an alkylene oxide with a dihydric alcohol or a polyhydric alcohol that is trihydric or more. Examples of the alkylene oxide may include ethylene oxide, propylene oxide, butylene oxide and an α-olefin oxide. Examples of the polyalkylene glycol, the dihydric alcohol and the polyhydric alcohol that is trihydric or more may include the components given as examples of the component for forming the polyester polyol described above. Those polyether polyols may be used alone or in combination thereof.

A polycarbonate diol produced by a known method may be used as the polycarbonate polyol. An example thereof may be polyhexamethylene carbonate, which is a hexanediol-based polycarbonate diol. The example may also be a polycarbonate diol obtained by causing a carbonate, such as an alkylene carbonate, a diaryl carbonate or a dialkyl carbonate, phosgene and an aliphatic diol to react with each other. Those polycarbonate diols may be used alone or in combination thereof.

Of the above-mentioned polyols having no acid groups, a polyether polyol is preferably used and polypropylene glycol is more preferably used. In a urethane resin including a unit derived from a polyether polyol such as polypropylene glycol, the branched chain of the polyether polyol such as polypropylene glycol serves as steric hindrance to suppress the formation of a hydrogen bond between the molecules of the urethane resin. The suppression of the hydrogen bond between the molecules of the urethane resin increases the number of the hydrogen bonding moieties of the resin that can form hydrogen bonds with the pigments. Accordingly, the amount of the urethane resin remaining on the pigment layer of an image increases and hence an improving effect on the light fastness of the image is more easily obtained.

[Polyol Having Acid Group]

Examples of the polyol having an acid group may include polyols each having an acid group, such as a carboxylic acid group, a sulfonic acid group, a phosphate group and a phosphonate group. The acid group is preferably a carboxylic acid group. Examples of the polyol having a carboxylic acid group may include dimethylolacetic acid, dimethylolpropionic acid and dimethylolbutanoic acid. The acid group of the polyol having an acid group may be of a salt type. As a cation for forming a salt, there may be given, for example: ions of alkali metals, such as lithium, sodium and potassium; an ammonium ion; and cations of organic amines such as dimethylamine. The polyols each having an acid group may be used alone or in combination thereof.

[Polyamine]

The urethane resin may be a product obtained by further performing a reaction with a polyamine. Examples of the polyamine may include: monoamines each having a plurality of hydroxy groups, such as dimethylolethylamine, diethanolmethylamine, dipropanolethylamine and dibutanolmethylamine; difunctional polyamines, such as ethylenediamine, propylenediamine, hexylenediamine, isophoronediamine, xylylenediamine, diphenylmethanediamine, hydrogenated diphenylmethanediamine and hydrazine; and trifunctional or higher polyamines, such as diethylenetriamine, triethylenetetramine, tetraethylenepentamine, a polyamide polyamine and a polyethylene polyimine. Those polyamines may be used alone or in combination thereof. In the foregoing, a compound having a plurality of hydroxy groups and one “amino group or imino group” is also given as an example of the “polyamine” for convenience.

[Crosslinking Agent and Chain Extender]

At the time of the synthesis of the urethane resin, a crosslinking agent or a chain extender may be used. Typically, the crosslinking agent is used at the time of the synthesis of a prepolymer and the chain extender is used when the prepolymer synthesized in advance is subjected to a chain-extending reaction. Basically, a product appropriately selected from, for example, water, a polyisocyanate, a polyol and a polyamine may be used as the crosslinking agent or the chain extender in accordance with purposes, such as crosslinking and chain extension. As the chain extender, the product that can crosslink the urethane resin may be used.

[Proportion of Unit Derived from Polyol Having Acid Group Present at Molecular Terminal]

In addition, in the urethane resin, the proportion of a unit derived from the polyol having an acid group present at a molecular terminal relative to the whole unit derived from the polyol having an acid group is preferably 30 mol % or less. When the above-mentioned proportion is 30 mol % or less, the urethane resin easily remains near the surface of a recording medium and hence the light fastness of an image is more easily improved. The proportion is preferably 0 mol % or more.

[Verification Method]

The proportion of the unit derived from the polyol having an acid group present at the molecular terminal relative to the whole unit derived from the polyol having an acid group in the urethane resin may be verified by the following method. The urethane resin prepared for the preparation of the ink or the urethane resin appropriately removed from the ink may be used as the urethane resin to be verified. First, the kinds of the polyisocyanate, the polyol having no acid group and the polyol having an acid group are identified through the analysis of the urethane resin by pyrolysis gas chromatography. Next, a reaction product of the polyisocyanate and the polyol having an acid group that have been identified is dissolved in deuterated dimethyl sulfoxide (deuterated DMSO) and the solution is analyzed by carbon nuclear magnetic resonance spectroscopy (¹³C-NMR). Thus, the chemical shift of carbonyl carbon (in lower magnetic fields) in the unit derived from the polyol having an acid group present at the molecular terminal is identified. Further, the chemical shift of carbonyl carbon (in higher magnetic fields) in the unit derived from the polyol having an acid group present in a molecule of the resin, is identified.

Next, the proportion of the peak integrated value of the carbonyl carbon in the unit derived from the polyol having an acid group present at the molecular terminal relative to the total of the peak integrated values of the carbonyl carbon in the unit derived from the polyol having an acid group is calculated. Thus, the proportion of the unit derived from the polyol having an acid group present at the molecular terminal relative to the whole unit derived from the polyol having an acid group in the urethane resin can be determined. For example, when dimethylolpropionic acid (DMPA) is used, the peak of the carbonyl carbon in the unit derived from the polyol having an acid group present at the molecular terminal is detected at around 176 ppm, though some deviation occurs depending on measurement conditions. In addition, the peak of the carbonyl carbon in the unit derived from the polyol having an acid group present in the molecule is detected at around 175 ppm. Further, when dimethylol butanoic acid (DMBA) is used, the peak of the carbonyl carbon in the unit derived from the polyol having an acid group present at the molecular terminal is detected at around 175 ppm. In addition, the peak of the carbonyl carbon in the unit derived from the polyol having an acid group present in the molecule is detected at around 174 ppm. The number-average molecular weight of the polyol may be calculated by determining the number of repetitions of the unit derived from the polyol through analysis by ¹³C-NMR described above.

(Silicone-Based Surfactant)

The ink includes at least one kind of silicone-based surfactant selected from the group consisting of compounds represented by the following respective general formulae (1) to (3). In the general formulae (1) to (3), (C₂H₄O) represents an ethylene oxide group and (C₃H₆O) represents a propylene oxide group. Each of the silicone-based surfactants has at least one of an ethylene oxide group and a propylene oxide group. An ethylene oxide group and a propylene oxide group may be present under any state, such as a random form or a block form, in the structure of each of the silicone-based surfactants. Herein, the fact that the respective groups are present under a random state means that an ethylene oxide group and a propylene oxide group are irregularly arrayed in the unit of a “group (unit).” In addition, the fact that the respective groups are present under a block state means that each block is formed by using the several “groups (units)” mentioned above as its units and the groups are arrayed in the unit of the block thus formed.

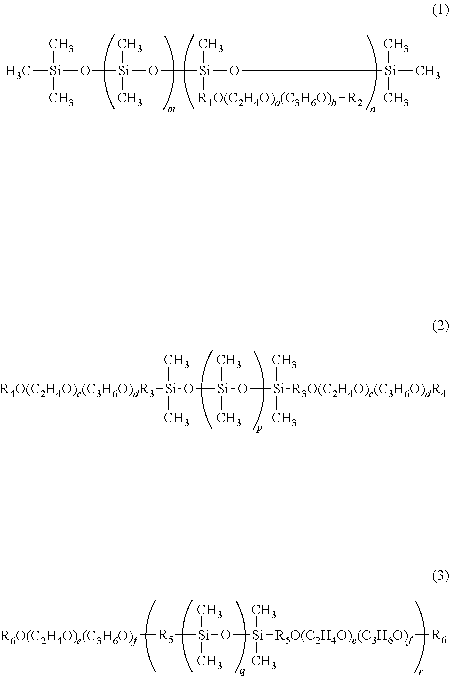

In the general formulae (1), (2) and (3), R₁, R₃ and R₅ each represent an alkylene group and R₂, R₄ and R₆ each represent a hydrogen atom or an alkyl group. “m”, “n”, “p”, “q” and “r” each represent an integer of 1 or more, where “m” and “n” are independent of each other and “q” and “r” are independent of each other. “a”, “b”, “c”, “d”, “e” and “f” each represent an integer of 0 or more, where “a” and “b” are independent of each other, “c” and “d” are independent of each other and “e” and “f” are independent of each other, provided that “a” and “b” each do not simultaneously represent 0, “c” and “d” each do not simultaneously represent 0 and “e” and “f” each do not simultaneously represent 0.

In the silicone-based surfactant, the alkylene group represented by each of R₁ in the general formula (1), R₃ in the general formula (2) and R₅ in the general formula (3) is preferably an alkylene group having 2 or more to 6 or less carbon atoms. The alkylene group is more preferably an ethylene group or a propylene group, still more preferably a propylene group.

In the silicone-based surfactant, the alkyl group that each of R₂ in the general formula (1), R₄ in the general formula (2) and R₆ in the general formula (3) may represent is preferably an alkyl group having 1 or more to 6 or less carbon atoms, more preferably a methyl group, an ethyl group or a propyl group. In the silicone-based surfactant, R₂, R₄ or R₆ in the general formulae (1) to (3) still more preferably represents a methyl group out of those groups. A methyl group is characterized in that the group has a low aggregating force and hence has a small interaction with an object. When the terminal of the ethylene oxide group and/or propylene oxide group of the silicone-based surfactant is a methyl group, the methyl group weakens an interaction between the molecules of the urethane resin to make their aggregation moderate. As a result, the uniformity of the film of the urethane resin formed on the pigment layer of an image is improved and hence the light fastness of the image is easily improved.

The compound represented by the general formula (1) is obtained by, for example, an addition reaction between a compound represented by the following general formula (A) and a compound represented by the following general formula (B). In addition, the compound represented by the general formula (2) is obtained by, for example, an addition reaction between a compound represented by the following general formula (C) and a compound represented by the following general formula (D). In addition, the compound represented by the general formula (3) is obtained by, for example, an addition reaction between a compound represented by the following general formula (E) and a compound represented by the following general formula (F). The compound represented by the general formula (A) is a polysiloxane compound having “n” hydrogen atoms bonded to “n” Si atoms in the general formula (A). The compound represented by the general formula (C) and the compound represented by the general formula (E) are each a polysiloxane compound having hydrogen atoms at both of its terminals. The compound represented by the general formula (B), the compound represented by the general formula (D) and the compound represented by the general formula (F) are each a polyoxyalkylene compound having an ethylene oxide group and/or a propylene oxide group.

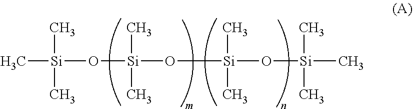

In the general formula (A), “m” and “n” are identical in meaning to “m” and “n” in the general formula (1), respectively.

R₁₁—O—(C₂H₄O)ₐ(C₃H₆O)_{b}—R₂ (B)

In the general formula (B), Ru represents an alkenyl group and R₂, “a” and “b” are identical in meaning to R₂, “a” and “b” in the general formula (1), respectively.

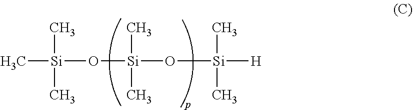

In the general formula (C), “p” is identical in meaning to “p” in the general formula (2).

R₃₁—O—(C₂F₁₄O)_{c}(C₃H₆O)_{d}—R₄ (D)

In the general formula (D), R₃₁ represents an alkenyl group and R₄, “c” and “d” are identical in meaning to R₄, “c” and “d” in the general formula (2), respectively.

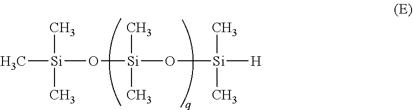

In the general formula (E), “q” is identical in meaning to “q” in the general formula (3).

R₆₁—O—(C₂H₄O)ₑ(C₃H₆O)_{f}—R₅₁ (F)

In the general formula (F), R₅₁ and R₆₁ each independently represent an alkenyl group and “e” and “f” are identical in meaning to “e” and “f” in the general formula (3), respectively.

R₁₁ in the general formula (B) represents a group that serves as R₁ in the general formula (1) through the addition reaction between the compound represented by the general formula (A) and the compound represented by the general formula (B). R₃₁ in the general formula (D) represents a group that serves as R₃ in the general formula (2) through the addition reaction between the compound represented by the general formula (C) and the compound represented by the general formula (D). R₅₁ and R₆₁ in the general formula (F) represent groups that serve as R₅ and R₆ in the general formula (3), respectively through the addition reaction between the compound represented by the general formula (E) and the compound represented by the general formula (F). The alkenyl group represented by each of Ru in the general formula (B), R₃₁ in the general formula (D), and R₅₁ and R₆₁ in the general formula (F) is preferably an alkenyl group having 2 or more to 6 or less carbon atoms, more preferably an allyl group.

The weight-average molecular weight (Mw) of the silicone-based surfactant is 800 or more to 10,000 or less. The weight-average molecular weight (Mw) is a weight-average molecular weight in terms of polystyrene in a molecular weight distribution measured by gel permeation chromatography (GPC). The molecular weight of the silicone-based surfactant represented by each of the general formulae (1) to (3) is determined as an average molecular weight because the surfactant is a mixture of molecules having various molecular weights.

[Measurement of Weight-Average Molecular Weight of Silicone-Based Surfactant]

The weight-average molecular weight (Mw) of the silicone-based surfactant may be measured by gel permeation chromatography (GPC) using tetrahydrofuran (THF) as a mobile phase. A method of measuring the Mw of the silicone-based surfactant is specifically as described below. The Mw of each of surfactants 1 to 13 used in Examples to be described later was measured by a preferred measurement method described below. Measurement conditions, such as a filter, a column, and a standard polystyrene sample and its molecular weight, are not limited to those described below.

First, the sample to be subjected to measurement is loaded into tetrahydrofuran (THF) and is left at rest for several hours to be dissolved therein. Thus, a solution is prepared. After that, the solution is filtered with a solvent-resistant membrane filter having a pore size of 0.2 μm to provide a sample solution. The concentration of the sample in the sample solution is adjusted so that the content of the silicone-based surfactant may be from 0.1% by mass to 0.3% by mass. A refractive index detector (RI detector) is used in the GPC. In addition, to accurately measure the molecular weight range of from 10³ to 2×10⁶, a plurality of commercial polystyrene gel columns are preferably combined. For example, four products of Shodex LF-804 (manufactured by Showa Denko K.K.) may be used in combination or products corresponding thereto may be used. THF is flowed as a mobile phase through the columns stabilized in a heat chamber at 40.0° C. at a flow rate of 1 mL/min and about 0.1 mL of the above-mentioned sample solution is injected into the columns. The weight-average molecular weight of the sample is determined with a molecular weight calibration curve produced from a standard polystyrene sample. A sample having a molecular weight of from about 10² to about 10⁷ (manufactured by, for example, Polymer Laboratories) is used as the standard polystyrene sample. In addition, it is appropriate to use at least about 10 kinds of standard polystyrene samples.

[HLB Value of Silicone-Based Surfactant]

An HLB value determined by Griffin's method is available as a physical property value representing the degree of the hydrophilicity or lipophilicity of a nonionic surfactant and has a value of 0 or more to 20 or less. A smaller HLB value means higher lipophilicity and a larger HLB value means higher hydrophilicity. The HLB value measured by Griffin's method may be calculated from the following equation (6). In the case of the above-mentioned silicone-based surfactant, the term “hydrophilic moieties” in the following equation (6) refers to an ethylene oxide group and/or a propylene oxide group.

HLB value=20×total sum of formula weights of hydrophilic moieties of surfactant/molecular weight of surfactant (6)

The HLB value of the silicone-based surfactant measured by Griffin's method is 4 or more. In addition, the HLB value is preferably 18 or less. When two or more kinds of silicone-based surfactants are incorporated into the ink, the HLB value of the silicone-based surfactants has the average of the HLB values of the two or more kinds of silicone-based surfactants (preferably an average weighted by their contents on a mass basis).

The content (% by mass) of the silicone-based surfactant in the ink is preferably 0.01% by mass or more to 1.00% by mass or less, more preferably 0.05% by mass or more to 0.50% by mass or less with respect to the total mass of the ink. In the ink, the mass ratio of the content (% by mass) of the first pigment to the content (% by mass) of the silicone-based surfactant is preferably 1.00 times or more to 15.00 times or less. In the ink, the mass ratio of the content (% by mass) of the second pigment to the content (% by mass) of the silicone-based surfactant is preferably 40.00 times or more to 55.00 times or less. In the ink, the mass ratio of the content (% by mass) of the water-soluble urethane resin to the content (% by mass) of the silicone-based surfactant is preferably 1.00 times or more to 60.00 times or less, more preferably 5.00 times or more to 20.00 times or less.

(Aqueous Medium)

The ink is an aqueous ink containing at least water as an aqueous medium. Deionized water (ion-exchanged water) is preferably used as the water. The content (% by mass) of the water in the ink is preferably 10.00% by mass or more to 90.00% by mass or less, more preferably 50.00% by mass or more to 90.00% by mass or less with respect to the total mass of the ink.

The aqueous medium may further contain a water-soluble organic solvent. Examples of the water-soluble organic solvent may include monohydric alcohols, polyhydric alcohols, (poly)alkylene glycols, glycol ethers, nitrogen-containing polar solvents and sulfur-containing polar solvents. One or two or more kinds of the water-soluble organic solvents may be used. The content (% by mass) of the water-soluble organic solvent in the ink is preferably 3.00% by mass or more to 50.00% by mass or less, more preferably 3.00% by mass or more to 30.00% by mass or less with respect to the total mass of the ink.

(Other Additives)

The ink may contain a water-soluble organic compound that is solid at normal temperature (25° C.), for example, a polyhydric alcohol, such as trimethylolpropane or trimethylolethane, urea or a urea derivative such as ethylene urea, as required in addition to the above-mentioned components. Further, the ink may contain any one of various additives, such as another resin, a pH adjuster, a rust inhibitor, an antiseptic, an antifungal agent, an antioxidant, an anti-reducing agent, an evaporation accelerator, a chelating agent and a water-soluble resin, as required.

(Physical Properties of Ink)

The viscosity of the ink at 25° C. is preferably 1.0 mPa·s or more to 10.0 mPa·s or less, more preferably 1.0 mPa·s or more to 5.0 mPa·s or less, particularly preferably 1.0 mPa·s or more to 3.0 mPa·s or less. The surface tension (static surface tension) of the ink at 25° C. is preferably 10.0 mN/m or more to 60.0 mN/m or less, more preferably 20.0 mN/m or more to 60.0 mN/m or less, particularly preferably 30.0 mN/m or more to 50.0 mN/m or less. The pH of the ink at 25° C. is preferably 5.0 or more to 10.0 or less, more preferably 7.0 or more to 9.5 or less.

<Ink Cartridge>

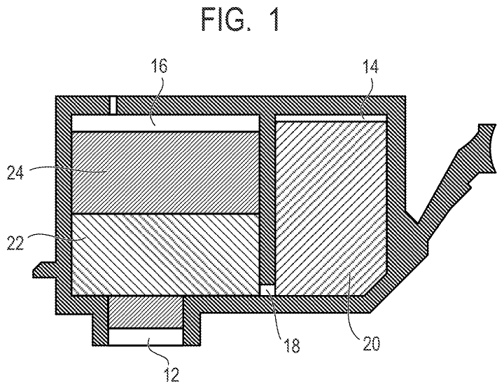

An ink cartridge of the present invention includes an ink and an ink storage portion configured to store the ink. In addition, the ink stored in the ink storage portion is the aqueous ink of the present invention described above. FIG. 1 is a sectional view for schematically illustrating an ink cartridge according to one embodiment of the present invention. As illustrated in FIG. 1, an ink supply port 12 for supplying an ink to a recording head is arranged on the bottom surface of the ink cartridge. The inside of the ink cartridge is the ink storage portion for storing the ink. The ink storage portion includes an ink storage chamber 14 and an absorbent storage chamber 16 and the chambers communicate to each other through a communication port 18. In addition, the absorbent storage chamber 16 communicates to the ink supply port 12. While a liquid ink 20 is stored in the ink storage chamber 14, absorbents 22 and 24 each configured to hold the ink in a state of being impregnated therewith are stored in the absorbent storage chamber 16. The ink storage portion may be of a form that is free of an ink storage chamber configured to store the liquid ink and is configured to hold the total amount of the ink to be stored with the absorbents. In addition, the ink storage portion may be of a form that is free of an absorbent and is configured to store the total amount of the ink in a liquid state. Further, an ink cartridge of a form formed to include the ink storage portion and a recording head may be adopted.

<Ink Jet Recording Method>

An ink jet recording method of the present invention is a method including ejecting the aqueous ink of the present invention described above from a recording head of an ink jet system to record an image on a recording medium. A system of ejecting the ink is, for example, a system involving applying mechanical energy to the ink or a system involving applying thermal energy to the ink. In the present invention, the system involving applying the thermal energy to the ink to eject the ink is particularly preferably adopted. The step of the ink jet recording method may be a known step except that the ink of the present invention is used. In the present invention, a step of applying the ink to the recording medium only needs to be performed and another treatment (e.g., a step of applying a reaction liquid that reacts with the ink, a step of curing the image through the application of, for example, an active energy ray or a step of heating the image) may not be performed.

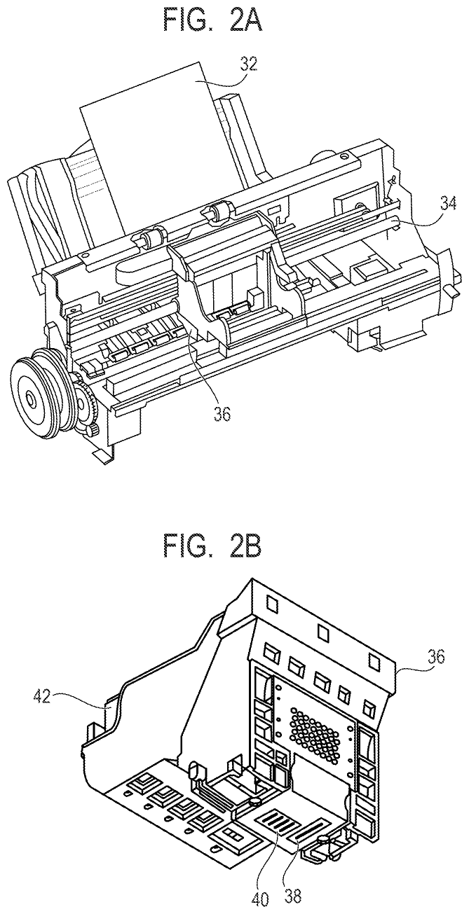

FIG. 2A and FIG. 2B are views for schematically illustrating an example of an ink jet recording apparatus to be used in the ink jet recording method of the present invention, in which FIG. 2A is a perspective view of the main portion of the ink jet recording apparatus and FIG. 2B is a perspective view of a head cartridge. A conveying unit (not shown) configured to convey a recording medium 32 and a carriage shaft 34 are arranged in the ink jet recording apparatus. A head cartridge 36 may be mounted on the carriage shaft 34. The head cartridge 36 includes recording heads 38 and 40 and is formed so that an ink cartridge 42 may be set therein. While the head cartridge 36 is conveyed along the carriage shaft 34 in a main scanning direction, the ink (not shown) is ejected from the recording heads 38 and 40 toward the recording medium 32. Then, the recording medium 32 is conveyed by the conveying unit (not shown) in a sub-scanning direction. Thus, the image is recorded on the recording medium 32.

Any recording medium may be used as the recording medium on which recording is to be performed with the ink of the present invention. However, a recording medium having ink permeability, such as plain paper or a recording medium including a coating layer (glossy paper or art paper), is preferably used. Of those, a recording medium including a coating layer is preferably used because at least part of pigment particles in the ink can be caused to exist on or near the surface of the recording medium. Such a recording medium may be selected in accordance with, for example, the intended uses of a recorded product having recorded thereon an image. Examples thereof include: glossy paper suitable for obtaining an image having a glossy feeling of photographic image quality; and art paper taking advantage of the texture (e.g., drawing paper-like, canvas-like or Japanese paper-like texture) of a substrate for representing, for example, a picture, a photograph and a graphic image in accordance with preference. Of those, so-called glossy paper in which the surface of its coating layer has glossiness is particularly preferably used.

### EXAMPLES

The present invention is described in more detail below by way of Examples and Comparative Examples. However, the present invention is by no means limited to Examples below, as long as the gist thereof is not exceeded. In the description of the amounts of components, “part(s)” and “%” are by mass unless otherwise specified.

<Preparation of Pigment>

The following solid solution pigment was prepared.

(Solid Solution Pigment 1)

To 364.4 parts of water, 23.4 parts of 3-amino-4-methoxybenzanilide was added and the mixture was sufficiently stirred to prepare a suspension, followed by the addition of ice to adjust its liquid temperature to 5° C. Thus, a suspension was obtained. To the suspension, 39.7 parts of 35% hydrochloric acid was added and the mixture was stirred for 1 hour. After that, an aqueous solution obtained by dissolving 7.1 parts of sodium nitrite in 22.0 parts of water was added to the mixture and the whole was stirred for 1 hour so that 3-amino-4-methoxybenzanilide was diazotized. Thus, a reaction liquid was obtained. To the resultant reaction liquid, 1.0 part of sulfamic acid was added to cause nitrous acid to disappear. After that, an aqueous solution containing 20.7 parts of sodium acetate, 1.8 parts of acetic acid and 165.0 parts of water was added to the resultant to provide a diazonium aqueous solution. To 31.8 parts of a 25% aqueous solution of sodium hydroxide and 414.0 parts of water, 15.0 parts of 3-hydroxy-2-naphthamide and 5.0 parts of 3-hydroxy-3′-nitro-2-naphthanilide were added, followed by sufficient stirring. Thus, a coupler aqueous solution was prepared. Then, the coupler aqueous solution was added to the diazonium aqueous solution prepared in the foregoing and the mixture was stirred for 1 hour so that a reaction therebetween was completed. After that, the mixture slurry was subjected to heating treatment to 70° C. Further, the heated slurry was filtered and washed with water to provide the press cake of the solid solution pigment of a naphthol AS-based azo pigment. Further, the press cake was dried under the conditions of 90° C. and 18 hours, followed by pulverization. Thus, a solid solution pigment 1 of C.I. Pigment Red 150 and C.I. Pigment Red 31 was obtained.

(Solid Solution Pigment 2)

A commercial pigment (product name: “Inkjet Magenta E7B 02 VP 3958”, manufactured by Clariant AG Corporation), which was a solid solution pigment of C.I. Pigment Red 122, C.I. Pigment Violet 19 and C.I. Pigment Red 202, was used as a solid solution pigment 2.

(Solid Solution Pigment 3)

A commercial pigment (product name: “Inkjet Magenta E 02”, manufactured by Clariant AG Corporation), which was a solid solution pigment of C.I. Pigment Red 122 and C.I. Pigment Violet 19, was used as a solid solution pigment 3.

(Solid Solution Pigment 4)

A commercial pigment (product name: “FASTOGEN Super Magenta JM2120”, manufactured by DIC Corporation), which was a solid solution pigment of C.I. Pigment Red 202 and C.I. Pigment Violet 19, was used as a solid solution pigment 4.

<Preparation of Pigment Dispersion Liquid>

By an ordinary method, 80.7 parts of styrene and 19.3 parts of acrylic acid were copolymerized to synthesize an acrylic resin 1 that was a water-soluble resin having an acid value of 150 mg KOH/g and a weight-average molecular weight of 8,000. The resultant acrylic resin 1 was dissolved in ion-exchanged water by adding potassium hydroxide whose molar amount was equal to the acid value of the resin. Thus, an aqueous solution of the acrylic resin 1 in which the content of the acrylic resin 1 was 20.00% was prepared.

The mixture of 10.0 parts of a pigment whose kind was shown in Table 1, 20.0 parts of the aqueous solution of the acrylic resin 1 and 70.0 parts of ion-exchanged water was loaded into a sand grinder and subjected to dispersion treatment for 1 hour. After that, centrifugation treatment was performed to remove a coarse particle and the residue was filtered with a microfilter having a pore size of 3.0 μm (manufactured by FUJIFILM Corporation) under pressure, followed by the addition of an appropriate amount of ion-exchanged water. Thus, respective pigment dispersion liquids in each of which the content of the pigment was 10.00% and the content of the acrylic resin 1 was 4.00% were obtained.

TABLE 1
Conditions for preparation of pigment dispersion liquids and their characteristics

| Pigment | | | | |
|---|---|---|---|---|
| dispersion | Pigment | | Content (%) | |
| liquid | Kind | Structure | Pigment | Resin |
| I-1 | C.I. Pigment Red 150 | Naphthol AS azo | 10.00 | 4.00 |
| I-2 | C.I. Pigment Red 31 | Naphthol AS azo | 10.00 | 4.00 |
| I-3 | C.I. Pigment Red 146 | Naphthol AS azo | 10.00 | 4.00 |
| I-4 | C.I. Pigment Red 147 | Naphthol AS azo | 10.00 | 4.00 |
| I-5 | C.I. Pigment Red 269 | Naphthol AS azo | 10.00 | 4.00 |
| I-6 | C.I. Pigment Red 22 | Naphthol AS azo | 10.00 | 4.00 |
| I-7 | Solid solution pigment 1 | Naphthol AS azo solid solution | 10.00 | 4.00 |
| I-8 | C.I. Pigment Red 185 | Naphthol AS azo | 10.00 | 4.00 |
| I-9 | C.I. Pigment Red 1 | Azo | 10.00 | 4.00 |
| I-10 | C.I. Pigment Red 48 | Azo | 10.00 | 4.00 |
| II-1 | Solid solution pigment 2 | Quinacridone solid solution | 10.00 | 4.00 |
| II-2 | Solid solution pigment 3 | Quinacridone solid solution | 10.00 | 4.00 |
| II-3 | Solid solution pigment 4 | Quinacridone solid solution | 10.00 | 4.00 |
| II-4 | C.I. Pigment Red 122 | Quinacridone | 10.00 | 4.00 |
| II-5 | C.I. Pigment Violet 19 | Quinacridone | 10.00 | 4.00 |
| II-6 | C.I. Pigment Red 149 | Anthraquinone | 10.00 | 4.00 |
| II-7 | C.I. Pigment Red 179 | Perylene | 10.00 | 4.00 |
| II-8 | C.I. Pigment Violet 23 | Dioxazine | 10.00 | 4.00 |
| II-9 | C.I. Pigment Red 254 | Diketopyrrolopyrrole | 10.00 | 4.00 |

<Synthesis of Urethane Resin>

(Urethane Resins 1 to 14)

A four-necked flask including a stirring machine, a temperature gauge, a nitrogen gas-introducing tube and a reflux tube was prepared. A polyisocyanate, a polyol having no acid group and a part (usage amount “a”) of dimethylolpropionic acid whose kinds and usage amounts were shown in Table 2, and 200.0 parts of methyl ethyl ketone were loaded into the four-necked flask. Then, the contents were caused to react with each other under a nitrogen gas atmosphere at 80° C. for 6 hours. Next, another part (usage amount “b”) of dimethylolpropionic acid, a chain extender and a stopper whose kinds and usage amounts were shown in Table 2, and 100.0 parts of methyl ethyl ketone were added to the resultant. The residual ratio of an isocyanate group was identified by FT-IR and the contents were caused to react with each other at 80° C. until a desired residual ratio was obtained. Thus, a reaction liquid was obtained. The resultant reaction liquid was cooled to 40° C. and then ion-exchanged water was added thereto. While the mixture was stirred with a homomixer at a high speed, an appropriate amount of ion-exchanged water and potassium hydroxide whose molar amount was equal to the acid value of the synthesized resin were added thereto to provide a liquid. Methyl ethyl ketone was evaporated from the resultant liquid through decompression under heating. Thus, liquids containing each of water-soluble urethane resins 1 to 14 in which urethane resin contents were each 20.00% were obtained. Each of the resultant urethane resins 1 to 14 was water-soluble. Abbreviations in Table 2 are as follows: IPDI: isophorone diisocyanate, HDI: hexamethylene diisocyanate, PPG: polypropylene glycol, PTMG: polytetramethylene glycol, EDA: ethylenediamine, NPG: neopentyl glycol, and MeOH: methanol, and numbers appended to PPG and PTMG each represent a number-average molecular weight.

(Proportion of Unit Derived from Polyol Having Acid Group Present at Molecular Terminal)

Hydrochloric acid was added to each of the liquids containing the urethane resins to precipitate the urethane resin. The resin was dried and dissolved in deuterated DMSO to prepare a measurement sample. Then, the prepared sample was analyzed by ¹³C-NMR (apparatus name: “Avance 500”, manufactured by BRUKER Bio Spin Corporation). Then, the proportion of the peak integrated value of the carbonyl carbon in a unit derived from a polyol having an acid group present at a molecular terminal relative to the total of the peak integrated values of the carbonyl carbon in the unit derived from the polyol having an acid group was calculated. The value (proportion) thus calculated was defined as the “proportion of a unit derived from the polyol having an acid group present at a molecular terminal”. For example, when dimethylolpropionic acid is used, the peak of the carbonyl carbon in the unit derived from the polyol having an acid group present at the molecular terminal is detected at around 176 ppm, though some deviation occurs depending on measurement conditions. In addition, the peak of the carbonyl carbon in the unit derived from the polyol having an acid group present in the molecule is detected at around 175 ppm. The results are each shown as “Terminal acid group proportion (mol %)” in Table 2.

TABLE 2
Conditions for synthesis of urethane resins and their characteristics

| | Synthesis condition | | | | | | | | | | |
|---|---|---|---|---|---|---|---|---|---|---|---|
| | | | | | Dimethylolpropionic | | | | | | |
| | | | Polyol having | | acid | | | | | | Characteristic |
| | Polyisocyanate | | no acid group | | Usage | Usage | Chain extender | | Stopper | | Terminal acid |
| | | Usage | | Usage | amount | amount | | Usage | | Usage | group |
| Urethane | | amount | | amount | “a” | “b” | | amount | | amount | proportion |
| resin | Kind | (part(s)) | Kind | (part(s)) | (part(s)) | (part(s)) | Kind | (part(s)) | Kind | (part(s)) | (mol %) |
| 1 | IPDI | 41.7 | PPG2000 | 40.1 | 13.2 | 2.4 | EDA | 0.6 | MeOH | 2.0 | 15 |
| 2 | IPDI | 41.7 | PPG2000 | 36.8 | 18.2 | 3.3 | — | — | — | — | 15 |
| 3 | IPDI | 28.0 | PPG2000 | 39.8 | 18.2 | 3.3 | — | — | — | — | 15 |
| | HDI | 10.7 | | | | | | | | | |
| 4 | HDI | 32.4 | PPG2000 | 46.1 | 18.2 | 3.3 | — | — | — | — | 15 |
| 5 | IPDI | 41.7 | PPG1500 | 36.8 | 18.2 | 3.3 | — | — | — | — | 15 |
| 6 | IPDI | 41.7 | PPG4000 | 36.8 | 18.2 | 3.3 | — | — | — | — | 15 |
| 7 | IPDI | 41.7 | PPG1000 | 36.8 | 18.2 | 3.3 | — | — | — | — | 15 |
| 8 | IPDI | 41.7 | PPG1000 | 34.2 | 18.2 | 3.3 | NPG | 0.6 | MeOH | 2.0 | 15 |
| 9 | IPDI | 41.7 | PPG8000 | 36.8 | 18.2 | 3.3 | — | — | — | — | 15 |
| 10 | IPDI | 41.7 | PTMG2000 | 34.2 | 18.2 | 3.3 | NPG | 0.6 | MeOH | 2.0 | 15 |
| 11 | IPDI | 41.7 | PPG2000 | 36.8 | 14.8 | 6.7 | — | — | — | — | 30 |
| 12 | IPDI | 41.7 | PPG2000 | 36.8 | 14.9 | 6.6 | — | — | — | — | 31 |
| 13 | IPDI | 41.7 | PPG2000 | 36.8 | 21.5 | 0.0 | — | — | — | — | 0 |
| 14 | IPDI | 41.7 | PPG2000 | 36.8 | 0.0 | 21.5 | — | — | — | — | 60 |

(Urethane Resin 15)

A four-necked flask including a stirring machine, a temperature gauge, a nitrogen gas-introducing tube and a reflux tube was prepared. Into the four-necked flask, 43.5 parts of polypropylene glycol (number-average molecular weight: 1,000), 44.5 parts of isophorone diisocyanate and 0.007 part of dibutyltin dilaurate were loaded. Then, the contents were caused to react with each other under a nitrogen gas atmosphere at 100° C. for 5 hours. After the reaction system had been cooled to about 60° C., 150.0 parts of methyl ethyl ketone, 9.0 parts of dimethylolpropionic acid and 3.0 parts of neopentyl glycol were added thereto and the inside of the reaction vessel was heated to 80° C., followed by a polymerization reaction. After that, the reaction system was cooled to room temperature and then 20.0 parts of methanol was added to stop the reaction. Next, water was added to the resultant. Further, while the mixture was stirred, an aqueous solution of potassium hydroxide was added to neutralize the mixture. Then, methyl ethyl ketone and unreacted methanol were evaporated by heating the mixed solution under reduced pressure. Thus, an aqueous solution of a urethane resin 15 in which the content of the water-soluble urethane resin was 20.00% was obtained. The terminal acid group proportion of the urethane resin 15 was 50 mol %.

(Urethane Resin 16)

A four-necked flask including a stirring machine, a temperature gauge, a nitrogen gas-introducing tube and a reflux tube was prepared. Into the four-necked flask, 39.7 parts of polytetramethylene glycol (number-average molecular weight: 2,000), 44.2 parts of isophorone diisocyanate and 0.007 part of dibutyltin dilaurate were loaded. Then, the contents were caused to react with each other under a nitrogen gas atmosphere at 100° C. for 5 hours. After the reaction system had been cooled to about 60° C., 150.0 parts of methyl ethyl ketone, 13.1 parts of dimethylolpropionic acid and 3.0 parts of neopentyl glycol were added thereto and the inside of the reaction vessel was heated to 80° C., followed by a polymerization reaction. After that, the reaction system was cooled to room temperature and then 20.0 parts of methanol was added to stop the reaction. Next, water was added to the resultant. Further, while the mixture was stirred, an aqueous solution of potassium hydroxide was added to neutralize the mixture. Then, methyl ethyl ketone and unreacted methanol were evaporated by heating the mixed solution under reduced pressure. Thus, an aqueous solution of a urethane resin 16 in which the content of the water-soluble urethane resin was 20.00% was obtained. The terminal acid group proportion of the urethane resin 16 was 50 mol %.

(Synthesis of Urethane Resin Particle)

Into a flask, 26.0 parts of neopentyl glycol, 20.0 parts of 1,4-butanediol, 54.0 parts of adipic acid and 0.003 part of an esterification catalyst (tetraisopropyl titanate) were loaded. After the mixture had been heated to 120° C. to be melted, its temperature was increased to 220° C. over from 3 hours to 4 hours while the mixture was stirred, followed by the holding of the temperature for 10 hours. The mixture was cooled to 100° C. to provide a polyester polyol having a number-average molecular weight of 2,000. Into a flask including a stirring machine, a reflux condenser, a temperature gauge and a nitrogen gas-introducing tube, 60.0 parts of the above-mentioned polyester polyol, 36.0 parts of isophorone diisocyanate, 4.0 parts of dimethylolpropionic acid and 60.1 parts of methyl ethyl ketone were loaded. The contents were caused to react with each other for 5 hours. After a 50% aqueous solution of potassium hydroxide had been added to neutralize a carboxylic acid group of the resultant, water was further added to the resultant and the mixture was sufficiently stirred. Next, the solvent was removed by heating the mixture under reduced pressure. Thus, an aqueous dispersion liquid of a urethane resin particle in which a resin particle content was 20.00% was obtained.

<Synthesis of Acrylic Resin 2>

A four-necked flask including a stirring machine, a reflux condenser and a nitrogen gas-introducing tube was prepared. Into the four-necked flask, 200.0 parts of ethylene glycol monobutyl ether was loaded and was stirred under a nitrogen gas atmosphere, followed by an increase in temperature thereof to 130° C. Into the flask, 65.0 parts of styrene, 20.0 parts of butyl acrylate and 15.0 parts of acrylic acid serving as monomers, and 4.0 parts of t-butyl peroxide serving as a polymerization initiator were dropped over 3 hours. The mixture was aged for 2 hours and then ethylene glycol monobutyl ether was evaporated under reduced pressure. Thus, a resin was obtained. Potassium hydroxide whose molar amount was equal to the acid value of the resultant resin and an appropriate amount of ion-exchanged water were added to the resin and the mixture was heated to 80° C. so that the resin was dissolved therein. Thus, an aqueous solution containing an acrylic resin 2 in which the content of the acrylic resin was 20.00% was obtained.

<Preparation of Surfactant>

(Surfactants 1 to 10)

A polysiloxane compound and a polyoxyalkylene compound described below were loaded into a glass-made vessel including a temperature gauge and a stirring unit. The compounds were subjected to an addition reaction in the presence of a platinum catalyst to synthesize each of surfactants 1 to 10. As the above-mentioned polysiloxane compound, compounds each represented by the general formula (A), and in which “m” and “n” in the general formula (A) each represented a number shown in Table 3 were each used. In addition, as the above-mentioned polyoxyalkylene compound, compounds each represented by the general formula (B), and in which “a”, “b”, Ru and R₂ in the general formula (B) each represented a number or a structure shown in Table 3 were each used. The respective surfactants obtained by the above-mentioned synthesis were compounds each represented by the general formula (1), and in which R₁ in the general formula (1) represented a structure shown in Table 3. “m”, “n”, “a”, “b” and R₂ in the general formula (1) correspond to “m”, “n”, “a”, “b” and R₂ in the general formulae (A) and (B) representing the structures of the respective compounds used in the synthesis, respectively. The weight-average molecular weights (Mw) and the HLB values of the resultant respective surfactants are also shown in Table 3.

TABLE 3
Conditions for synthesis of surfactants 1 to 10 and their
characteristics

| | | | | | | | | | HLB |
|---|---|---|---|---|---|---|---|---|---|
| Surfactant | m | n | a | b | R₁₁ | R₂ | R₁ | Mw | value |
| 1 | 5 | 1 | 14 | 0 | CH₂═CH—CH₂ | CH₃ | (CH₂)₃ | 1,200 | 11 |
| 2 | 2 | 1 | 10 | 0 | CH₂═CH—CH₂ | CH₃ | (CH₂)₃ | 800 | 11 |
| 3 | 6 | 4 | 25 | 20 | CH₂═CH—CH₂ | CH₃ | (CH₂)₃ | 10,000 | 9 |
| 4 | 12 | 1 | 6 | 0 | CH₂═CH—CH₂ | CH₃ | (CH₂)₃ | 1,200 | 4 |
| 5 | 1 | 2 | 50 | 0 | CH₂═CH—CH₂ | CH₃ | (CH₂)₃ | 4,800 | 18 |
| 6 | 2 | 1 | 13 | 0 | CH₂═CH—CH₂ | H | (CH₂)₃ | 900 | 13 |
| 7 | 2 | 1 | 13 | 0 | CH₂═CH—CH₂ | CH₂CH₃ | (CH₂)₃ | 900 | 12 |
| 8 | 2 | 1 | 8 | 0 | CH₂═CH—CH₂ | CH₃ | (CH₂)₃ | 700 | 10 |
| 9 | 6 | 5 | 20 | 20 | CH₂═CH—CH₂ | CH₃ | (CH₂)₃ | 11,000 | 8 |
| 10 | 17 | 1 | 5 | 0 | CH₂═CH—CH₂ | CH₃ | (CH₂)₃ | 1,500 | 3 |

(Surfactants 11 and 12)

A polysiloxane compound and a polyoxyalkylene compound described below were loaded into a glass-made vessel including a temperature gauge and a stirring unit. The compounds were subjected to an addition reaction in the presence of a platinum catalyst to synthesize each of surfactants 11 and 12. As the above-mentioned polysiloxane compound, a compound represented by the general formula (C), and in which “p” in the general formula (C) represented a number shown in Table 4 was used. In addition, as the above-mentioned polyoxyalkylene compound, compounds each represented by the general formula (D), and in which “c”, “d”, R₃₁ and R₄ in the general formula (D) each represented a number or a structure shown in Table 4 were each used. The respective surfactants obtained by the above-mentioned synthesis were compounds each represented by the general formula (2), and in which R₃ in the general formula (2) represented a structure shown in Table 4. “p”, “c”, “d” and R₄ in the general formula (2) correspond to “p”, “c”, “d” and R₄ in the general formulae (C) and (D) representing the structures of the respective compounds used in the synthesis, respectively. The weight-average molecular weights (Mw) and HLB values of the resultant respective surfactants are also shown in Table 4.

TABLE 4
Conditions for synthesis of surfactants 11 and 12, and their
characteristics

| | | | | | | | | HLB |
|---|---|---|---|---|---|---|---|---|
| Surfactant | p | c | d | R₃₁ | R₄ | R₃ | Mw | value |
| 11 | 8 | 11 | 0 | CH₂═CH—CH₂ | CH₃ | (CH₂)₃ | 1,700 | 12 |
| 12 | 8 | 11 | 0 | CH₂═CH—CH₂ | H | (CH₂)₃ | 1,700 | 12 |

(Surfactant 13)

A polysiloxane compound and a polyoxyalkylene compound described below were loaded into a glass-made vessel including a temperature gauge and a stirring unit. The compounds were subjected to an addition reaction in the presence of a platinum catalyst to synthesize a surfactant 13. As the above-mentioned polysiloxane compound, a compound represented by the general formula (E), and in which “q” in the general formula (E) represented a number shown in Table 5 was used. In addition, as the above-mentioned polyoxyalkylene compound, a compound represented by the general formula (F), and in which “e”, “f”, R₅₁ and R₆₁ in the general formula (F) each represented a number or a structure shown in Table 5 was used. The surfactant obtained by the above-mentioned synthesis was a compound represented by the general formula (3), and in which R₅ and R₆ in the general formula (3) each represented a structure shown in Table 5. “q”, “e” and “f” in the general formula (3) correspond to “q”, “e” and “f” in the general formulae (E) and (F) representing the structures of the respective compounds used in the synthesis, respectively. In addition, “r” in the general formula (3) corresponds to “r” shown in Table 5. The weight-average molecular weight (Mw) and the HLB value of the resultant surfactant are also shown in Table 5.

TABLE 5
Conditions for synthesis of surfactant 13 and its characteristics

| | | | | | | | | | | HLB |
|---|---|---|---|---|---|---|---|---|---|---|
| Surfactant | q | r | e | f | R₅₁ | R₆₁ | R₅ | R₆ | Mw | value |
| 13 | 8 | 2 | 10 | 0 | CH₂═CH—CH₂ | CH₂═CH—CH₂ | (CH₂)₃ | (CH₂)₂CH₃ | 2,100 | 13 |

(Surfactants 14 to 19)

Commercial surfactants 14 to 19 shown below were used.

Surfactant 14
Product name “ACETYLENOL E100” (manufactured by Kawaken Fine Chemicals Co., Ltd.), acetylene glycol-based surfactant

Surfactant 15
Product name “Captone FS3100” (manufactured by DuPont Corporation), fluorine-based surfactant

Surfactant 16
Product name “NIKKOL BC-20” (manufactured by Nikko Chemicals Co., Ltd.), polyoxyethylene alkyl ether-based surfactant

Surfactant 17
Product name “SURFYNOL 440” (manufactured by Nissin Chemical Industry Co., Ltd.), acetylene glycol-based surfactant

Surfactant 18
Product name “SUNNOL NL-1430” (manufactured by Lion Corporation), polyoxyethylene alkyl ether-based surfactant

Surfactant 19
Product name “SURFYNOL 420” (manufactured by Nissin Chemical Industry Co., Ltd.), acetylene glycol-based surfactant

<Preparation of Ink>

Respective components (unit: %) shown in the middle stage of each of Tables 6 (Tables 6-1 to 6-8) were mixed and sufficiently stirred. After that, the mixture was filtered with a microfilter having a pore size of 3.0 μm (manufactured by FUJIFILM Corporation) under pressure to prepare each of inks. Materials whose kinds (numbers) were shown in the upper stage of each of Tables 6 were used as “Pigment dispersion liquid I,” “Pigment dispersion liquid II,” “Aqueous solution of urethane resin” and “Surfactant” shown in the middle stage of each of Tables 6, respectively. However, the symbol “-” in the upper stages of Tables 6 means that the corresponding material was not used. The term “Proxel GXL” in the middle stage of each of Tables 6 represents the product name of an antiseptic manufactured by Arch Chemicals, Inc. The characteristics of the inks are collectively shown in the lower stages of Tables 6. That is, a content A (%) of the first pigment (each pigment in pigment dispersion liquids I-1 to I-8), a content Q (%) of the second pigment (each pigment in pigment dispersion liquids II-1 to II-5), a content P (%) of the pigments, a content U (%) of the urethane resin and a content S (%) of the silicone-based surfactant are shown. Similarly, a value of P/U (times), a value of A/P (times), a value of Q/P (times), a value of A/Q (times), a value of A/S (times), a value of Q/S (times) and a value of U/S (times) are shown.

TABLE 6
Compositions and characteristics of inks

| | Example | | | | | | | |
|---|---|---|---|---|---|---|---|---|
| | 1 | 2 | 3 | 4 | 5 | 6 | 7 | 8 |
| Kind of pigment dispersion liquid I | I-1 | I-1 | I-1 | I-1 | I-1 | I-1 | I-1 | I-1 |
| Kind of pigment dispersion liquid II | II-1 | II-2 | II-1 | II-1 | II-1 | II-1 | II-1 | II-1 |
| Kind of urethane resin | 1 | 1 | 1 | 1 | 1 | 1 | 1 | 2 |
| Kind of surfactant | 1 | 1 | 2 | 3 | 4 | 5 | 11 | 1 |
| Pigment dispersion liquid I | 5.00 | 5.00 | 5.00 | 5.00 | 5.00 | 5.00 | 5.00 | 5.00 |
| Pigment dispersion liquid II | 50.00 | 50.00 | 50.00 | 50.00 | 50.00 | 50.00 | 50.00 | 50.00 |
| Aqueous solution of urethane resin | 5.00 | 5.00 | 5.00 | 5.00 | 5.00 | 5.00 | 5.00 | 5.00 |
| Surfactant | 0.10 | 0.10 | 0.10 | 0.10 | 0.10 | 0.10 | 0.10 | 0.10 |
| Aqueous dispersion liquid of urethane | | | | | | | | |
| resin particle | | | | | | | | |
| Aqueous solution of acrylic resin 2 | | | | | | | | |
| Glycerin | 10.00 | 10.00 | 10.00 | 10.00 | 10.00 | 10.00 | 10.00 | 10.00 |
| Triethylene glycol | 5.00 | 5.00 | 5.00 | 5.00 | 5.00 | 5.00 | 5.00 | 5.00 |
| Proxel GXL | 0.05 | 0.05 | 0.05 | 0.05 | 0.05 | 0.05 | 0.05 | 0.05 |
| Ion-exchanged water | 24.85 | 24.85 | 24.85 | 24.85 | 24.85 | 24.85 | 24.85 | 24.85 |
| Content A of first pigment (%) | 0.50 | 0.50 | 0.50 | 0.50 | 0.50 | 0.50 | 0.50 | 0.50 |
| Content Q of second pigment (%) | 5.00 | 5.00 | 5.00 | 5.00 | 5.00 | 5.00 | 5.00 | 5.00 |
| Content P of pigment (%) | 5.50 | 5.50 | 5.50 | 5.50 | 5.50 | 5.50 | 5.50 | 5.50 |
| Content U of urethane resin (%) | 1.00 | 1.00 | 1.00 | 1.00 | 1.00 | 1.00 | 1.00 | 1.00 |
| Content S of silicone-based surfactant | 0.10 | 0.10 | 0.10 | 0.10 | 0.10 | 0.10 | 0.10 | 0.10 |
| (%) | | | | | | | | |
| Value of P/U (times) | 5.50 | 5.50 | 5.50 | 5.50 | 5.50 | 5.50 | 5.50 | 5.50 |
| Value of A/P (times) | 0.09 | 0.09 | 0.09 | 0.09 | 0.09 | 0.09 | 0.09 | 0.09 |
| Value of Q/P (times) | 0.91 | 0.91 | 0.91 | 0.91 | 0.91 | 0.91 | 0.91 | 0.91 |
| Value of A/Q (times) | 0.10 | 0.10 | 0.10 | 0.10 | 0.10 | 0.10 | 0.10 | 0.10 |
| Value of A/S (times) | 5.00 | 5.00 | 5.00 | 5.00 | 5.00 | 5.00 | 5.00 | 5.00 |
| Value of Q/S (times) | 50.00 | 50.00 | 50.00 | 50.00 | 50.00 | 50.00 | 50.00 | 50.00 |
| Value of U/S (times) | 10.00 | 10.00 | 10.00 | 10.00 | 10.00 | 10.00 | 10.00 | 10.00 |
| | Example | | | | | | | |
| | 9 | 10 | 11 | 12 | 13 | 14 | 15 | 16 |
| Kind of pigment dispersion liquid I | I-1 | I-1 | I-1 | I-1 | I-1 | I-1 | I-1 | I-6 |
| Kind of pigment dispersion liquid II | II-1 | II-1 | II-1 | II-1 | II-1 | II-1 | II-1 | II-1 |
| Kind of urethane resin | 3 | 1 | 1 | 1 | 1 | 1 | 1 | 1 |
| Kind of surfactant | 1 | 1 | 1 | 1 | 1 | 1 | 1 | 1 |
| Pigment dispersion liquid I | 5.00 | 5.00 | 5.00 | 5.00 | 14.50 | 11.00 | 2.70 | 5.00 |
| Pigment dispersion liquid II | 50.00 | 50.00 | 50.00 | 50.00 | 40.50 | 44.00 | 52.30 | 50.00 |
| Aqueous solution of urethane resin | 5.00 | 29.50 | 27.50 | 1.30 | 5.00 | 5.00 | 5.00 | 5.00 |
| Surfactant | 0.10 | 0.10 | 0.10 | 0.10 | 0.10 | 0.10 | 0.10 | 0.10 |
| Aqueous dispersion liquid of urethane | | | | | | | | |
| resin particle | | | | | | | | |
| Aqueous solution of acrylic resin 2 | | | | | | | | |
| Glycerin | 10.00 | 10.00 | 10.00 | 10.00 | 10.00 | 10.00 | 10.00 | 10.00 |
| Triethylene glycol | 5.00 | 5.00 | 5.00 | 5.00 | 5.00 | 5.00 | 5.00 | 5.00 |
| Proxel GXL | 0.05 | 0.05 | 0.05 | 0.05 | 0.05 | 0.05 | 0.05 | 0.05 |
| Ion-exchanged water | 24.85 | 0.35 | 2.35 | 28.55 | 24.85 | 24.85 | 24.85 | 24.85 |
| Content A of first pigment (%) | 0.50 | 0.50 | 0.50 | 0.50 | 1.45 | 1.10 | 0.27 | 0.50 |
| Content Q of second pigment (%) | 5.00 | 5.00 | 5.00 | 5.00 | 4.05 | 4.40 | 5.23 | 5.00 |
| Content P of pigment (%) | 5.50 | 5.50 | 5.50 | 5.50 | 5.50 | 5.50 | 5.50 | 5.50 |
| Content U of urethane resin (%) | 1.00 | 5.90 | 5.50 | 0.26 | 1.00 | 1.00 | 1.00 | 1.00 |
| Content S of silicone-based surfactant | 0.10 | 0.10 | 0.10 | 0.10 | 0.10 | 0.10 | 0.10 | 0.10 |
| (%) | | | | | | | | |
| Value of P/U (times) | 5.50 | 0.93 | 1.00 | 21.15 | 5.50 | 5.50 | 5.50 | 5.50 |
| Value of A/P (times) | 0.09 | 0.09 | 0.09 | 0.09 | 0.26 | 0.20 | 0.05 | 0.09 |
| Value of Q/P (times) | 0.91 | 0.91 | 0.91 | 0.91 | 0.74 | 0.80 | 0.95 | 0.91 |
| Value of A/Q (times) | 0.10 | 0.10 | 0.10 | 0.10 | 0.36 | 0.25 | 0.05 | 0.10 |
| Value of A/S (times) | 5.00 | 5.00 | 5.00 | 5.00 | 14.50 | 11.00 | 2.70 | 5.00 |
| Value of Q/S (times) | 50.00 | 50.00 | 50.00 | 50.00 | 40.50 | 44.00 | 52.30 | 50.00 |
| Value of U/S (times) | 10.00 | 59.00 | 55.00 | 2.60 | 10.00 | 10.00 | 10.00 | 10.00 |
| | Example | | | | | | | |
| | 17 | 18 | 19 | 20 | 21 | 22 | 23 | 24 |
| Kind of pigment dispersion liquid I | I-2 | I-3 | I-4 | I-5 | I-1 | I-1 | I-1 | I-1 |
| Kind of pigment dispersion liquid II | II-1 | II-1 | II-1 | II-1 | II-3 | II-4 | II-5 | II-1 |
| Kind of urethane resin | 1 | 1 | 1 | 1 | 1 | 1 | 1 | 1 |
| Kind of surfactant | 1 | 1 | 1 | 1 | 1 | 1 | 1 | 6 |
| Pigment dispersion liquid I | 5.00 | 5.00 | 5.00 | 5.00 | 5.00 | 5.00 | 5.00 | 5.00 |
| Pigment dispersion liquid II | 50.00 | 50.00 | 50.00 | 50.00 | 50.00 | 50.00 | 50.00 | 50.00 |
| Aqueous solution of urethane resin | 5.00 | 5.00 | 5.00 | 5.00 | 5.00 | 5.00 | 5.00 | 5.00 |
| Surfactant | 0.10 | 0.10 | 0.10 | 0.10 | 0.10 | 0.10 | 0.10 | 0.10 |
| Aqueous dispersion liquid of urethane | | | | | | | | |
| resin particle | | | | | | | | |
| Aqueous solution of acrylic resin 2 | | | | | | | | |
| Glycerin | 10.00 | 10.00 | 10.00 | 10.00 | 10.00 | 10.00 | 10.00 | 10.00 |
| Triethylene glycol | 5.00 | 5.00 | 5.00 | 5.00 | 5.00 | 5.00 | 5.00 | 5.00 |
| Proxel GXL | 0.05 | 0.05 | 0.05 | 0.05 | 0.05 | 0.05 | 0.05 | 0.05 |
| Ion-exchanged water | 24.85 | 24.85 | 24.85 | 24.85 | 24.85 | 24.85 | 24.85 | 24.85 |
| Content A of first pigment (%) | 0.50 | 0.50 | 0.50 | 0.50 | 0.50 | 0.50 | 0.50 | 0.50 |
| Content Q of second pigment (%) | 5.00 | 5.00 | 5.00 | 5.00 | 5.00 | 5.00 | 5.00 | 5.00 |
| Content P of pigment (%) | 5.50 | 5.50 | 5.50 | 5.50 | 5.50 | 5.50 | 5.50 | 5.50 |
| Content U of urethane resin (%) | 1.00 | 1.00 | 1.00 | 1.00 | 1.00 | 1.00 | 1.00 | 1.00 |
| Content S of silicone-based surfactant | 0.10 | 0.10 | 0.10 | 0.10 | 0.10 | 0.10 | 0.10 | 0.10 |
| (%) | | | | | | | | |
| Value of P/U (times) | 5.50 | 5.50 | 5.50 | 5.50 | 5.50 | 5.50 | 5.50 | 5.50 |
| Value of A/P (times) | 0.09 | 0.09 | 0.09 | 0.09 | 0.09 | 0.09 | 0.09 | 0.09 |
| Value of Q/P (times) | 0.91 | 0.91 | 0.91 | 0.91 | 0.91 | 0.91 | 0.91 | 0.91 |
| Value of A/Q (times) | 0.10 | 0.10 | 0.10 | 0.10 | 0.10 | 0.10 | 0.10 | 0.10 |
| Value of A/S (times) | 5.00 | 5.00 | 5.00 | 5.00 | 5.00 | 5.00 | 5.00 | 5.00 |
| Value of Q/S (times) | 50.00 | 50.00 | 50.00 | 50.00 | 50.00 | 50.00 | 50.00 | 50.00 |
| Value of U/S (times) | 10.00 | 10.00 | 10.00 | 10.00 | 10.00 | 10.00 | 10.00 | 10.00 |
| | Example | | | | | | | |
| | 25 | 26 | 27 | 28 | 29 | 30 | 31 | 32 |
| Kind of pigment dispersion liquid I | I-1 | I-1 | I-1 | I-1 | I-1 | I-1 | I-1 | I-1 |
| Kind of pigment dispersion liquid II | II-1 | II-1 | II-1 | II-1 | II-1 | II-1 | II-1 | II-1 |
| Kind of urethane resin | 1 | 1 | 1 | 4 | 7 | 8 | 5 | 6 |
| Kind of surfactant | 12 | 7 | 13 | 1 | 1 | 1 | 1 | 1 |
| Pigment dispersion liquid I | 5.00 | 5.00 | 5.00 | 5.00 | 5.00 | 5.00 | 5.00 | 5.00 |
| Pigment dispersion liquid II | 50.00 | 50.00 | 50.00 | 50.00 | 50.00 | 50.00 | 50.00 | 50.00 |
| Aqueous solution of urethane resin | 5.00 | 5.00 | 5.00 | 5.00 | 5.00 | 5.00 | 5.00 | 5.00 |
| Surfactant | 0.10 | 0.10 | 0.10 | 0.10 | 0.10 | 0.10 | 0.10 | 0.10 |
| Aqueous dispersion liquid of urethane | | | | | | | | |
| resin particle | | | | | | | | |
| Aqueous solution of acrylic resin 2 | | | | | | | | |
| Glycerin | 10.00 | 10.00 | 10.00 | 10.00 | 10.00 | 10.00 | 10.00 | 10.00 |
| Triethylene glycol | 5.00 | 5.00 | 5.00 | 5.00 | 5.00 | 5.00 | 5.00 | 5.00 |
| Proxel GXL | 0.05 | 0.05 | 0.05 | 0.05 | 0.05 | 0.05 | 0.05 | 0.05 |
| Ion-exchanged water | 24.85 | 24.85 | 24.85 | 24.85 | 24.85 | 24.85 | 24.85 | 24.85 |
| Content A of first pigment (%) | 0.50 | 0.50 | 0.50 | 0.50 | 0.50 | 0.50 | 0.50 | 0.50 |
| Content Q of second pigment (%) | 5.00 | 5.00 | 5.00 | 5.00 | 5.00 | 5.00 | 5.00 | 5.00 |
| Content P of pigment (%) | 5.50 | 5.50 | 5.50 | 5.50 | 5.50 | 5.50 | 5.50 | 5.50 |
| Content U of urethane resin (%) | 1.00 | 1.00 | 1.00 | 1.00 | 1.00 | 1.00 | 1.00 | 1.00 |
| Content S of silicone-based surfactant | 0.10 | 0.10 | 0.10 | 0.10 | 0.10 | 0.10 | 0.10 | 0.10 |
| (%) | | | | | | | | |
| Value of P/U (times) | 5.50 | 5.50 | 5.50 | 5.50 | 5.50 | 5.50 | 5.50 | 5.50 |
| Value of A/P (times) | 0.09 | 0.09 | 0.09 | 0.09 | 0.09 | 0.09 | 0.09 | 0.09 |
| Value of Q/P (times) | 0.91 | 0.91 | 0.91 | 0.91 | 0.91 | 0.91 | 0.91 | 0.91 |
| Value of A/Q (times) | 0.10 | 0.10 | 0.10 | 0.10 | 0.10 | 0.10 | 0.10 | 0.10 |
| Value of A/S (times) | 5.00 | 5.00 | 5.00 | 5.00 | 5.00 | 5.00 | 5.00 | 5.00 |
| Value of Q/S (times) | 50.00 | 50.00 | 50.00 | 50.00 | 50.00 | 50.00 | 50.00 | 50.00 |
| Value of U/S (times) | 10.00 | 10.00 | 10.00 | 10.00 | 10.00 | 10.00 | 10.00 | 10.00 |
| | Example | | | | | | | |
| | 33 | 34 | 35 | 36 | 37 | 38 | | |
| Kind of pigment dispersion liquid I | I-1 | I-1 | I-1 | I-1 | I-1 | I-1 | | |
| Kind of pigment dispersion liquid II | II-1 | II-1 | II-1 | II-1 | II-1 | II-1 | | |
| Kind of urethane resin | 9 | 10 | 13 | 11 | 12 | 14 | | |
| Kind of surfactant | 1 | 1 | 1 | 1 | 1 | 1 | | |
| Pigment dispersion liquid I | 5.00 | 5.00 | 5.00 | 5.00 | 5.00 | 5.00 | | |
| Pigment dispersion liquid II | 50.00 | 50.00 | 50.00 | 50.00 | 50.00 | 50.00 | | |
| Aqueous solution of urethane resin | 5.00 | 5.00 | 5.00 | 5.00 | 5.00 | 5.00 | | |
| Surfactant | 0.10 | 0.10 | 0.10 | 0.10 | 0.10 | 0.10 | | |
| Aqueous dispersion liquid of urethane | | | | | | | | |
| resin particle | | | | | | | | |
| Aqueous solution of acrylic resin 2 | | | | | | | | |
| Glycerin | 10.00 | 10.00 | 10.00 | 10.00 | 10.00 | 10.00 | | |
| Triethylene glycol | 5.00 | 5.00 | 5.00 | 5.00 | 5.00 | 5.00 | | |
| Proxel GXL | 0.05 | 0.05 | 0.05 | 0.05 | 0.05 | 0.05 | | |
| Ion-exchanged water | 24.85 | 24.85 | 24.85 | 24.85 | 24.85 | 24.85 | | |
| Content A of first pigment (%) | 0.50 | 0.50 | 0.50 | 0.50 | 0.50 | 0.50 | | |
| Content Q of second pigment (%) | 5.00 | 5.00 | 5.00 | 5.00 | 5.00 | 5.00 | | |
| Content P of pigment (%) | 5.50 | 5.50 | 5.50 | 5.50 | 5.50 | 5.50 | | |
| Content U of urethane resin (%) | 1.00 | 1.00 | 1.00 | 1.00 | 1.00 | 1.00 | | |
| Content S of silicone-based surfactant | 0.10 | 0.10 | 0.10 | 0.10 | 0.10 | 0.10 | | |
| (%) | | | | | | | | |
| Value of P/U (times) | 5.50 | 5.50 | 5.50 | 5.50 | 5.50 | 5.50 | | |
| Value of A/P (times) | 0.09 | 0.09 | 0.09 | 0.09 | 0.09 | 0.09 | | |
| Value of Q/P (times) | 0.91 | 0.91 | 0.91 | 0.91 | 0.91 | 0.91 | | |
| Value of A/Q (times) | 0.10 | 0.10 | 0.10 | 0.10 | 0.10 | 0.10 | | |
| Value of A/S (times) | 5.00 | 5.00 | 5.00 | 5.00 | 5.00 | 5.00 | | |
| Value of Q/S (times) | 50.00 | 50.00 | 50.00 | 50.00 | 50.00 | 50.00 | | |
| Value of U/S (times) | 10.00 | 10.00 | 10.00 | 10.00 | 10.00 | 10.00 | | |
| | Comparative Example | | | | | | | |
| | 1 | 2 | 3 | 4 | 5 | 6 | 7 | |
| Kind of pigment dispersion liquid I | — | — | I-9 | I-10 | I-1 | I-1 | I-1 | |
| Kind of pigment dispersion liquid II | II-1 | II-1 | II-1 | II-1 | — | — | II-6 | |
| Kind of urethane resin | 1 | 1 | 1 | 1 | 1 | 1 | 1 | |
| Kind of surfactant | 1 | — | 1 | 1 | 1 | — | 1 | |
| Pigment dispersion liquid I | | | 5.00 | 5.00 | 55.00 | 55.00 | 5.00 | |
| Pigment dispersion liquid II | 55.00 | 55.00 | 50.00 | 50.00 | | | 50.00 | |
| Aqueous solution of urethane resin | 5.00 | 5.00 | 5.00 | 5.00 | 5.00 | 5.00 | 5.00 | |
| Surfactant | 0.10 | | 0.10 | 0.10 | 0.10 | | 0.10 | |
| Aqueous dispersion liquid of urethane | | | | | | | | |
| resin particle | | | | | | | | |
| Aqueous solution of acrylic resin 2 | | | | | | | | |
| Glycerin | 10.00 | 10.00 | 10.00 | 10.00 | 10.00 | 10.00 | 10.00 | |
| Triethylene glycol | 5.00 | 5.00 | 5.00 | 5.00 | 5.00 | 5.00 | 5.00 | |
| Proxel GXL | 0.05 | 0.05 | 0.05 | 0.05 | 0.05 | 0.05 | 0.05 | |
| Ion-exchanged water | 24.85 | 24.95 | 24.85 | 24.85 | 24.85 | 24.95 | 24.85 | |
| Content A of first pigment (%) | 0.00 | 0.00 | 0.00 | 0.00 | 5.50 | 5.50 | 0.50 | |
| Content Q of second pigment (%) | 5.50 | 5.50 | 5.00 | 5.00 | 0.00 | 0.00 | 0.00 | |
| Content P of pigment (%) | 5.50 | 5.50 | 5.50 | 5.50 | 5.50 | 5.50 | 5.50 | |
| Content U of urethane resin (%) | 1.00 | 1.00 | 1.00 | 1.00 | 1.00 | 1.00 | 1.00 | |
| Content S of silicone-based surfactant | 0.10 | 0.00 | 0.10 | 0.10 | 0.10 | 0.00 | 0.10 | |
| (%) | | | | | | | | |
| Value of P/U (times) | 5.50 | 5.50 | 5.50 | 5.50 | 5.50 | 5.50 | 5.50 | |
| Value of A/P (times) | 0.00 | 0.00 | 0.00 | 0.00 | 1.00 | 1.00 | 0.09 | |
| Value of Q/P (times) | 1.00 | 1.00 | 0.91 | 0.91 | 0.00 | 0.00 | 0.00 | |
| Value of A/Q (times) | 0.00 | 0.00 | 0.00 | 0.00 | — | — | — | |
| Value of A/S (times) | 0.00 | — | 0.00 | 0.00 | 55.00 | — | 5.00 | |
| Value of Q/S (times) | 55.00 | — | 50.00 | 50.00 | 0.00 | — | 0.00 | |
| Value of U/S (times) | 10.00 | — | 10.00 | 10.00 | 10.00 | — | 10.00 | |
| | Comparative Example | | | | | | | |
| | 8 | 9 | 10 | 11 | 12 | 13 | 14 | |
| Kind of pigment dispersion liquid I | I-1 | I-1 | I-1 | I-1 | I-1 | I-1 | I-1 | |
| Kind of pigment dispersion liquid II | II-7 | II-8 | II-9 | II-1 | II-1 | II-1 | II-1 | |
| Kind of urethane resin | 1 | 1 | 1 | — | — | — | — | |
| Kind of surfactant | 1 | 1 | 1 | 1 | — | 1 | 1 | |
| Pigment dispersion liquid I | 5.00 | 5.00 | 5.00 | 5.00 | 5.00 | 5.00 | 5.00 | |
| Pigment dispersion liquid II | 50.00 | 50.00 | 50.00 | 50.00 | 50.00 | 50.00 | 50.00 | |
| Aqueous solution of urethane resin | 5.00 | 5.00 | 5.00 | | | | | |
| Surfactant | 0.10 | 0.10 | 0.10 | 0.10 | | 0.10 | 0.10 | |
| Aqueous dispersion liquid of urethane | | | | | | 5.00 | | |
| resin particle | | | | | | | | |
| Aqueous solution of acrylic resin 2 | | | | | | | 5.00 | |
| Glycerin | 10.00 | 10.00 | 10.00 | 10.00 | 10.00 | 10.00 | 10.00 | |
| Triethylene glycol | 5.00 | 5.00 | 5.00 | 5.00 | 5.00 | 5.00 | 5.00 | |
| Proxel GXL | 0.05 | 0.05 | 0.05 | 0.05 | 0.05 | 0.05 | 0.05 | |
| Ion-exchanged water | 24.85 | 24.85 | 24.85 | 29.85 | 29.95 | 24.85 | 24.85 | |
| Content A of first pigment (%) | 0.50 | 0.50 | 0.50 | 0.50 | 0.50 | 0.50 | 0.50 | |
| Content Q of second pigment (%) | 0.00 | 0.00 | 0.00 | 5.00 | 5.00 | 5.00 | 5.00 | |
| Content P of pigment (%) | 5.50 | 5.50 | 5.50 | 5.50 | 5.50 | 5.50 | 5.50 | |
| Content U of urethane resin (%) | 1.00 | 1.00 | 1.00 | 0.00 | 0.00 | 1.00 | 0.00 | |
| Content S of silicone-based surfactant | 0.10 | 0.10 | 0.10 | 0.10 | 0.00 | 0.10 | 0.10 | |
| (%) | | | | | | | | |
| Value of P/U (times) | 5.50 | 5.50 | 5.50 | — | — | 5.50 | — | |
| Value of A/P (times) | 0.09 | 0.09 | 0.09 | 0.09 | 0.09 | 0.09 | 0.09 | |
| Value of Q/P (times) | 0.00 | 0.00 | 0.00 | 0.91 | 0.91 | 0.91 | 0.91 | |
| Value of A/Q (times) | — | — | — | 0.10 | 0.10 | 0.10 | 0.10 | |
| Value of A/S (times) | 5.00 | 5.00 | 5.00 | 5.00 | — | 5.00 | 5.00 | |
| Value of Q/S (times) | 0.00 | 0.00 | 0.00 | 50.00 | — | 50.00 | 50.00 | |
| Value of U/S (times) | 10.00 | 10.00 | 10.00 | 0.00 | — | 10.00 | 0.00 | |
| | Comparative Example | | | | | | | |
| | 15 | 16 | 17 | 18 | 19 | 20 | 21 | |
| Kind of pigment dispersion liquid I | I-1 | I-1 | I-1 | I-1 | I-1 | I-1 | I-1 | |
| Kind of pigment dispersion liquid II | II-1 | II-1 | II-1 | II-1 | II-1 | II-1 | II-1 | |
| Kind of urethane resin | 1 | 1 | 1 | 1 | 1 | 1 | 1 | |
| Kind of surfactant | — | 14 | 15 | 16 | 8 | 9 | 10 | |
| Pigment dispersion liquid I | 5.00 | 5.00 | 5.00 | 5.00 | 5.00 | 5.00 | 5.00 | |
| Pigment dispersion liquid II | 50.00 | 50.00 | 50.00 | 50.00 | 50.00 | 50.00 | 50.00 | |
| Aqueous solution of urethane resin | 5.00 | 5.00 | 5.00 | 5.00 | 5.00 | 5.00 | 5.00 | |
| Surfactant | | 0.10 | 0.10 | 0.10 | 0.10 | 0.10 | 0.10 | |
| Aqueous dispersion liquid of urethane | | | | | | | | |
| resin particle | | | | | | | | |
| Aqueous solution of acrylic resin 2 | | | | | | | | |
| Glycerin | 10.00 | 10.00 | 10.00 | 10.00 | 10.00 | 10.00 | 10.00 | |
| Triethylene glycol | 5.00 | 5.00 | 5.00 | 5.00 | 5.00 | 5.00 | 5.00 | |
| Proxel GXL | 0.05 | 0.05 | 0.05 | 0.05 | 0.05 | 0.05 | 0.05 | |
| Ion-exchanged water | 24.95 | 24.85 | 24.85 | 24.85 | 24.85 | 24.85 | 24.85 | |
| Content A of first pigment (%) | 0.50 | 0.50 | 0.50 | 0.50 | 0.50 | 0.50 | 0.50 | |
| Content Q of second pigment (%) | 5.00 | 5.00 | 5.00 | 5.00 | 5.00 | 5.00 | 5.00 | |
| Content P of pigment (%) | 5.50 | 5.50 | 5.50 | 5.50 | 5.50 | 5.50 | 5.50 | |
| Content U of urethane resin (%) | 1.00 | 1.00 | 1.00 | 1.00 | 1.00 | 1.00 | 1.00 | |
| Content S of silicone-based surfactant | 0.00 | 0.00 | 0.00 | 0.00 | 0.00 | 0.00 | 0.00 | |
| (%) | | | | | | | | |
| Value of P/U (times) | 5.50 | 5.50 | 5.50 | 5.50 | 5.50 | 5.50 | 5.50 | |
| Value of A/P (times) | 0.09 | 0.09 | 0.09 | 0.09 | 0.09 | 0.09 | 0.09 | |
| Value of Q/P (times) | 0.91 | 0.91 | 0.91 | 0.91 | 0.91 | 0.91 | 0.91 | |
| Value of A/Q (times) | 0.10 | 0.10 | 0.10 | 0.10 | 0.10 | 0.10 | 0.10 | |
| Value of A/S (times) | — | — | — | — | — | — | — | |
| Value of Q/S (times) | — | — | — | — | — | — | — | |
| Value of U/S (times) | — | — | — | — | — | — | — | |

### Comparative Example 22

Respective components described below were mixed and sufficiently stirred. After that, the mixture was filtered with a microfilter having a pore size of 3.0 μm (manufactured by FUJIFILM Corporation) under pressure to prepare an ink of Comparative Example 22. The ink was an ink free of the second pigment.
Pigment dispersion liquid I-7: 40.00%
Aqueous solution of urethane resin 15: 25.00%
Surfactant 10: 1.00%
1,2-Pentanediol: 15.00%
Proxel GXL: 0.05%
Ion-exchanged water: 18.95%

### Comparative Example 23

Respective components described below were mixed and sufficiently stirred. After that, the mixture was filtered with a microfilter having a pore size of 3.0 μm (manufactured by FUJIFILM Corporation) under pressure to prepare an ink of Comparative Example 23. The ink was an ink free of a water-soluble urethane resin and the surfactants represented by the respective general formulae (1) to (3).
Pigment dispersion liquid I-1: 24.00%
Pigment dispersion liquid II-3: 56.00%
Surfactant 17: 0.40%
Surfactant 18: 0.40%
Glycerin: 8.00%
Polyethylene glycol having number-average molecular weight of 200: 3.00%
Triethylene glycol: 5.00%
Triethylene glycol-n-butyl ether: 2.00%
Ion-exchanged water: 1.20%

### Comparative Example 24

Respective components described below were mixed and sufficiently stirred. After that, the mixture was filtered with a microfilter having a pore size of 3.0 μm (manufactured by FUJIFILM Corporation) under pressure to prepare an ink of Comparative Example 24. The ink was an ink free of a water-soluble urethane resin.
Pigment dispersion liquid I-1: 15.60%
Pigment dispersion liquid II-2: 34.51%
Surfactant 6: 0.50%
Glycerin: 10.00%
Butyl diglycol: 20.00%
Ion-exchanged water: 19.39%

### Comparative Example 25

Respective components described below were mixed and sufficiently stirred. After that, the mixture was filtered with a microfilter having a pore size of 3.0 μm (manufactured by FUJIFILM Corporation) under pressure to prepare an ink of Comparative Example 25. The ink was an ink free of the surfactants represented by the respective general formulae (1) to (3).
Pigment dispersion liquid I-8: 25.00%
Pigment dispersion liquid II-4: 15.00%
Aqueous solution of urethane resin 16: 25.00%
Surfactant 19: 1.00%
1,2-Pentanediol: 15.00%
Ion-exchanged water: 19.00%<

<Evaluation>

The following respective evaluations were performed by using the respective prepared inks. In Examples of the present invention, in the evaluation criteria of each of the following evaluation items, while levels “AA”, “A” and “B” were defined as acceptable levels, levels “C” and “D” were defined as unacceptable levels. An ink jet recording apparatus (product name: “PIXUS PRO-10”) mounted with a recording head that ejected an ink with thermal energy was used in the evaluations. In Examples of the present invention, an image recorded under such a condition that 35 ng of an ink was applied to a unit region measuring 1/600 inch by 1/600 inch was defined as having a recording duty of 100%. The evaluations were performed in an environment at a temperature of 25° C. and a relative humidity of 55%. The evaluation results are shown in Tables 7 (Tables 7-1 and 7-2).

(Color Developability)

Each of the prepared inks was loaded into an ink cartridge and the cartridge was set in the above-mentioned ink jet recording apparatus. A solid image having a recording duty of 50% was recorded on a recording medium (glossy paper, product name: “Canon Photo Paper, Glossy Gold GL-101”, manufactured by Canon Inc.) and was dried in an environment at 25° C. for 1 day. The optical density of the solid image was measured with a spectrophotometer (product name: “FD-7”, manufactured by Konica Minolta, Inc.) under the conditions of a light source of D50 and a field of view of 2°. The optical density of a magenta component in the resultant optical density was evaluated in accordance with the following evaluation criteria.
A: The optical density was 2.0 or more.
B: The optical density was 1.8 or more to less than 2.0.
C: The optical density was 1.6 or more to less than 1.8.

(Light Fastness)

Each of the prepared inks was loaded into an ink cartridge and the cartridge was set in the above-mentioned ink jet recording apparatus. A solid image having a recording duty of 5% was recorded on a recording medium (matte paper, product name: “Canon Photo Paper, Premium Matte PM-101”, manufactured by Canon Inc.) and was dried in an environment at 25° C. for 1 day. The optical density of the recorded solid image was measured with a spectrophotometer (product name: “FD-7”, manufactured by Konica Minolta, Inc.) (optical density before a light fastness test). After that, the solid image was loaded into a xenon light testing apparatus (low-temperature cycle xenon weather meter XL-75C: manufactured by Suga Test Instruments Co., Ltd.). Then, xenon light was applied to the image at an illuminance of 50 klx, an in-tank air temperature of 23° C., a relative humidity of 50% and a black panel temperature of 23° C. until an integrated irradiance became 33,400 klx·hr. After that, the optical density of the solid image was measured (optical density after the light fastness test). An optical density residual ratio (%) (=(optical density after light fastness test/optical density before light fastness test)×100) was calculated from the resultant values of the optical densities before and after the light fastness test, followed by the evaluation of the light fastness of the image in accordance with the following evaluation criteria.
AA: The optical density residual ratio was 90% or more.
A: The optical density residual ratio was 80% or more to less than 90%.
B: The optical density residual ratio was 75% or more to less than 80%.
C: The optical density residual ratio was 70% or more to less than 75%.
D: The optical density residual ratio was less than 70%.

(Intermittent Ejection Stability)

Each of the prepared inks was loaded into the ink cartridge and the cartridge was set in the above-mentioned ink jet recording apparatus. After a solid image having a recording duty of 50% had been recorded on one sheet of a recording medium (glossy paper, product name: “Canon Photo Paper, Glossy Gold GL-101”, manufactured by Canon Inc.), the ink jet recording apparatus was paused for a predetermined time period. After that, the ink was ejected from each of the ejection orifices of the apparatus only once. When the ink is normally ejected, a vertical ruler line having substantially the same width as that of an ejection orifice array is recorded. The recorded line was visually observed and the intermittent ejection stability of the ink was evaluated in accordance with the following evaluation criteria.
AA: At the time point when the pause time was 10 minutes, the ink was normally ejected from 90% or more of all the ejection orifices.
A: When the pause time was 5 minutes or more to less than 10 minutes, the ink was normally ejected from 90% or more of all the ejection orifices.
B: When the pause time was 1 minute or more to less than 5 minutes, the ink was normally ejected from 90% or more of all the ejection orifices.
C: When the pause time was 15 seconds or more to less than 1 minute, the ink was normally ejected from 90% or more of all the ejection orifices.
D: When the pause time reached 15 seconds or more, the ink was not normally ejected from 90% or more of all the ejection orifices and was ejected in a twisted manner or no longer ejected.

TABLE 7
Evaluation results

| | | Color | Light | Intermittent |
|---|---|---|---|---|
| | | developability | fastness | ejection stability |
| Example | 1 | A | AA | AA |
| | 2 | A | AA | AA |
| | 3 | A | AA | AA |
| | 4 | A | AA | AA |
| | 5 | A | AA | AA |
| | 6 | A | AA | AA |
| | 7 | A | AA | AA |
| | 8 | A | AA | AA |
| | 9 | A | AA | AA |
| | 10 | B | AA | AA |
| | 11 | A | AA | AA |
| | 12 | A | AA | AA |
| | 13 | A | A | AA |
| | 14 | A | AA | AA |
| | 15 | A | AA | AA |
| | 16 | A | B | B |
| | 17 | A | A | A |
| | 18 | A | A | A |
| | 19 | A | A | A |
| | 20 | A | A | A |
| | 21 | A | A | AA |
| | 22 | A | A | AA |
| | 23 | A | A | AA |
| | 24 | A | A | AA |
| | 25 | A | A | AA |
| | 26 | A | B | A |
| | 27 | A | B | A |
| | 28 | A | A | A |
| | 29 | A | A | AA |
| | 30 | A | A | AA |
| | 31 | A | AA | AA |
| | 32 | A | AA | AA |
| Example | 33 | A | A | A |
| | 34 | A | A | AA |
| | 35 | A | AA | AA |
| | 36 | A | AA | AA |
| | 37 | A | A | AA |
| | 38 | A | A | AA |
| Comparative | 1 | C | AA | A |
| Example | 2 | C | C | A |
| | 3 | C | AA | A |
| | 4 | C | AA | A |
| | 5 | A | C | A |
| | 6 | A | C | A |
| | 7 | A | C | A |
| | 8 | A | C | A |
| | 9 | A | C | A |
| | 10 | A | C | A |
| | 11 | A | C | A |
| | 12 | A | C | A |
| | 13 | A | C | A |
| | 14 | A | C | A |
| | 15 | A | C | C |
| | 16 | A | C | C |
| | 17 | A | C | C |
| | 18 | A | C | C |
| | 19 | A | C | C |
| | 20 | A | C | C |
| | 21 | A | C | C |
| | 22 | B | C | A |
| | 23 | A | D | A |
| | 24 | A | D | A |
| | 25 | A | C | C |

According to the present invention, the aqueous ink that can record an image, which is satisfactory in a color developability and light fastness, and has satisfactory intermittent ejection stability can be provided. In addition, according to the present invention, the ink cartridge and the ink jet recording method each using the aqueous ink can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-126675, filed Aug. 8, 2022, and Japanese Patent Application No. 2023-114071, filed Jul. 11, 2023, which are hereby incorporated by reference herein in their entirety.

What is claimed is:

1. An aqueous ink for ink jet comprising:
pigments;
a urethane resin; and
a silicone-based surfactant,
wherein the pigments include a first pigment and a second pigment, the first pigment is a naphthol AS-based azo pigment and the second pigment is a quinacridone-based pigment,
wherein the urethane resin is a water-soluble urethane resin having a unit derived from a polyisocyanate, a unit derived from a polyol having no acid group and a unit derived from a polyol having an acid group, and
wherein the silicone-based surfactant is at least one kind selected from the group consisting of compounds represented by the following respective general formulae (1) to (3), has a weight-average molecular weight of 800 or more to 10,000 or less and has an HLB value measured by Griffin's method of 4 or more: 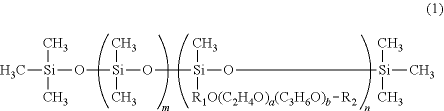
in the general formula (1), R₁ represents an alkylene group, R₂ represents a hydrogen atom or an alkyl group, “m” and “n” each independently represent an integer of 1 or more and “a” and “b” each independently represent an integer of 0 or more but do not simultaneously represent 0; 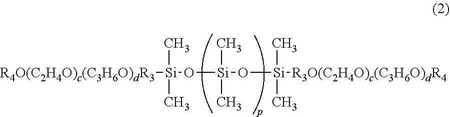
in the general formula (2), R₃ represents an alkylene group, R₄ represents a hydrogen atom or an alkyl group, “p” represents an integer of 1 or more and “c” and “d” each independently represent an integer of 0 or more but do not simultaneously represent 0; 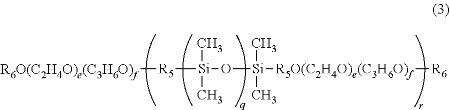
in the general formula (3), R₅ represents an alkylene group, R₆ represents a hydrogen atom or an alkyl group, “q” and “r” each independently represent an integer of 1 or more and “e” and “f” each independently represent an integer of 0 or more but do not simultaneously represent 0.

2. The aqueous ink according to claim 1, wherein in the aqueous ink, a mass ratio of a content (% by mass) of the pigments to a content (% by mass) of the urethane resin is 1.00 times or more.

3. The aqueous ink according to claim 1, wherein in the aqueous ink, a mass ratio of a content (% by mass) of the second pigment to a content (% by mass) of the pigments is 0.80 times or more.

4. The aqueous ink according to claim 1, wherein the first pigment comprises at least one kind selected from the group consisting of C.I. Pigment Reds 31, 146, 147, 150 and 269.

5. The aqueous ink according to claim 1, wherein the first pigment comprises C.I. Pigment Red 150.

6. The aqueous ink according to claim 1, wherein the second pigment comprises a solid solution pigment containing C.I. Pigment Red 122 and C.I. Pigment Violet 19.

7. The aqueous ink according to claim 1, wherein in the silicone-based surfactant, R₂ in the general formula (1), R₄ in the general formula (2) or R₆ in the general formula (3) represents a methyl group.

8. The aqueous ink according to claim 1, wherein the polyisocyanate comprises isophorone diisocyanate.

9. The aqueous ink according to claim 1, wherein the polyol having no acid group has a number-average molecular weight of 1,500 or more to 4,000 or less.

10. The aqueous ink according to claim 1, wherein the polyol having no acid group comprises polypropylene glycol.

11. The aqueous ink according to claim 1, wherein in the urethane resin, a proportion of a unit derived from the polyol having an acid group present at a molecular terminal relative to the whole unit derived from the polyol having an acid group is 30 mol % or less.

12. An ink cartridge comprising:
an ink; and
an ink storage portion configured to store the ink,
wherein the ink comprises the aqueous ink according to claim 1.

13. An ink jet recording method comprising ejecting an ink from a recording head of an ink jet system to record an image on a recording medium,
wherein the ink comprises the aqueous ink according to claim 1.
